(19) United States
(12) Patent Application Publication
(10) Pub. No.: US 2022/0358483 A1
(43) Pub. Date: Nov. 10, 2022

(54) TRANSACTION PROCESSING SYSTEM

(71) Applicant: TOSHIBA TEC KABUSHIKI KAISHA, Tokyo (JP)

(72) Inventors: Kentaro KOHNO, Mishima Shizuoka (JP); Katsuhito MOCHIZUKI, Izunokuni Shizuoka (JP); Shigeki NIMIYA, Yokohama Kanagawa (JP); Fumio NAKATSUKASA, Yokohama Kanagawa (JP); Mikio ITO, Ota Tokyo (JP); Tsuyoshi KAWAMOTO, Nerima Tokyo (JP); Kiyomitu YAMAGUCHI, Izunokuni Shizuoka (JP)

(21) Appl. No.: 17/873,908

(22) Filed: Jul. 26, 2022

Related U.S. Application Data
(63) Continuation of application No. 17/104,277, filed on Nov. 25, 2020.

(30) Foreign Application Priority Data
Feb. 6, 2020 (JP) 2020-018823

(51) Int. Cl. G06Q 20/32; G06F 9/48; G06Q 20/20

(52) U.S. Cl. CPC G06Q 20/3223; G06F 9/4881; G06Q 20/204; G06Q 20/202

(57) ABSTRACT

In accordance with an embodiment, a transaction processing system includes a plurality of terminal devices, a transaction processing apparatus, and a management processing apparatus. The plurality of terminal devices includes a terminal device belonging to a first type and a terminal device belonging to a second type. The transaction processing apparatus performs concurrently a plurality of transaction processes for processing transactions in accordance with instructions from the plurality of terminal devices. The management processing apparatus performs a management process for managing the transaction processes performed concurrently by the transaction processing apparatus.

### CROSS-REFERENCE TO RELATED APPLICATION

This application is a continuation of U.S. patent application Ser. No. 17/104,277, filed on Nov. 25, 2020, which is based upon and claims the benefit of priority from the prior Japanese Patent Application No. 2020-018823, filed on Feb. 6, 2020, the entire contents of which are incorporated herein by reference.

### FIELD

An embodiment described here generally relates to a transaction processing system.

### BACKGROUND

A transaction processing system for registering a purchased commodity in response to an operation by a customer at a terminal device such as a cart terminal attached to a shopping cart or a portable information communication terminal owned by the customer has been considered. In such a transaction processing system, it is assumed that a customer takes out an arbitrary cart terminal from a place near the entrance of a store or the like, and starts shopping using the cart terminal. Therefore, it is desirable to lower the possibility of a situation where purchased commodities cannot be registered using cart terminals. As described above, it has been desired to be able to lower the possibility of a situation where a process according to a specific type of terminal device cannot be performed in a case of processing transactions in response to instructions from a plurality of types of terminal devices.

### BRIEF DESCRIPTION OF THE DRAWINGS

FIG. 1 is a block diagram showing a schematic configuration of a transaction processing system according to an embodiment.

FIG. 2 is a block diagram showing a circuit configuration of a store server in FIG. 1.

FIG. 3 is a block diagram showing a circuit configuration of the virtual POS server in FIG. 1.

FIG. 4 is a block diagram showing a functional configuration of the apparatus according to a block embodiment showing a circuit configuration of a mobile controller in Fig.

FIG. 5 is a schematic diagram showing a main data structure of a data record included in the transaction management database shown in FIG. 4.

FIG. 6 is a schematic diagram showing a main data structure of a data record included in the registration database shown in FIG. 4.

FIG. 7 is a block diagram showing a circuit configuration of the user terminal in FIG. 1.

FIG. 8 is a block diagram showing a circuit configuration of a cart terminal in FIG. 1.

FIG. 9 is a flowchart showing an example of a smartphone UI process.

FIG. 10 is a flowchart showing an example of the smartphone UI process.

FIG. 11 is a flowchart showing an example of the smartphone UI process.

FIG. 12 is a flowchart showing an example of the smartphone UI process.

FIG. 13 is a flowchart showing an example of a cart UI process.

FIG. 14 is a flowchart showing an example of a management process.

FIG. 15 is a flowchart showing an example of a mediation process.

FIG. 16 is a flowchart showing an example of the mediation process.

FIG. 17 is a flowchart showing an example of a transaction process.

FIG. 18 is a diagram showing an example of a list screen.

FIG. 19 is a diagram showing an example of a registration screen.

FIG. 20 is a diagram showing an example of a list screen.

FIG. 21 is a diagram showing an example of a payment screen.

### DETAILED DESCRIPTION

In accordance with one embodiment, the transaction processing system includes a plurality of terminal devices, a transaction processing apparatus, and a management processing apparatus. The plurality of terminal devices includes a plurality of terminal devices belonging to a first type and a plurality of terminal devices belonging to a second type. The transaction processing apparatus performs concurrently a plurality of transaction processes for processing transactions in accordance with instructions from the plurality of terminal devices. The management processing apparatus performs a management process for managing the transaction processes performed concurrently by the transaction processing apparatus. The management processing apparatus includes a communication interface, a storage device, and a processor. The communication interface communicates with the plurality of terminal devices and the transaction processing apparatus. The storage device stores a predetermined allowable number of transaction processes to be performed by the transaction processing apparatus in accordance with an instruction from the terminal device belonging to the first type. The processor compares the number of running processes of the transaction processes performed by the transaction processing apparatus with the allowable number stored in the storage device in accordance with an instruction from the terminal device belonging to the first type when the processor receives a request to start transaction from the terminal device belonging to the first type via the communication interface. In addition, the processor rejects, in a case where the number of running processes is equal to the allowable number, the request to start the transaction from the terminal device belonging to the first type via the communication interface.

Hereinafter, an embodiment of the transaction processing system will be described with reference to the drawings. The transaction processing system according to this embodiment processes a transaction of commodities in a store which sells commodities displayed in the store to visiting customers. The same reference signs in the figures will denote the same or similar portions.

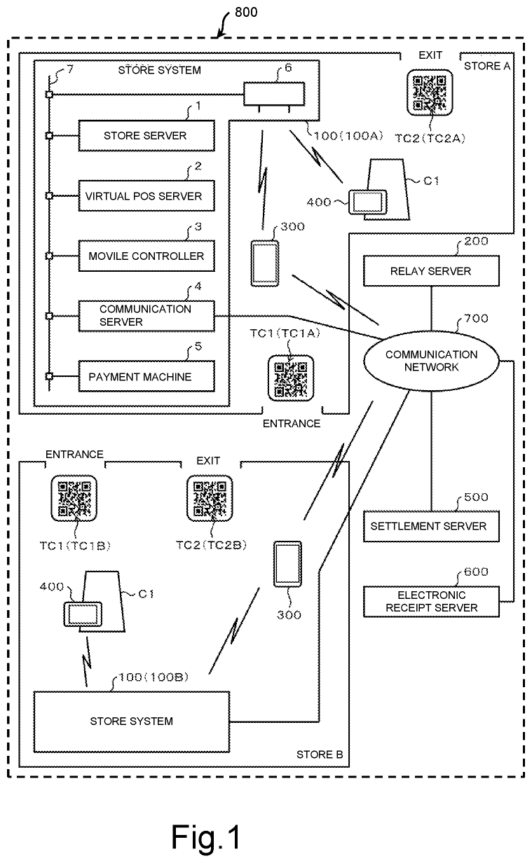

FIG. 1 is a block diagram showing a schematic configuration of the transaction processing system according to the embodiment. A transaction processing system 800 includes a plurality of store systems 100, a relay server 200, user terminals 300, cart terminals 400, a settlement server 500, an electronic receipt server 600, and a communication network 700. The plurality of store systems 100, the relay server 200, the user terminals 300, the settlement server 500, and the electronic receipt server 600 are communicable with one another via the communication network 700.

In FIG. 1, two store systems 100 are shown. These store systems 100 are respectively provided in different stores A and B using the transaction processing system 800. There may be three or more stores using the transaction processing system 800, and the store system 100 is provided in each store. It should be noted that hereinafter, as it is necessary to distinguish the store system 100 provided in each store, the store system 100 provided in the store A will be referred to as a store system 100A, and the store system 100 provided in the store B will be referred to as a store system 100B. The business operator operating the store A may be the same as or different from the business operator operating the store B. In a case where the transaction processing system 800 is used in another store, the business operator operating the store may be the same as or different from the business operator operating the store A or the store B.

The relay server 200 relays data communication between the user terminal 300 and the store system 100. The relay server 200 provides, for example, a relay function for data communication as a cloud service via the communication network 700.

The user terminal 300 is a portable information communication terminal that functions as a user interface for the customer who shops by using the transaction processing system 800 in the store. The user terminal 300 has a function of wirelessly communicating with the store system 100 and a function of wirelessly communicating with the communication network 700. A communication terminal having a data communication function such as a smartphone and a tablet terminal can be used as the user terminal 300. The user terminal 300 is owned by the customer. That is, the user terminal 300 is an example of a terminal device belonging to a first type that is brought into the store by the customer.

The cart terminal 400 is a portable information communication terminal that functions as a user interface for the customer who shops by using the transaction processing system 800 in the store. The cart terminal 400 has a function of wirelessly communicating with the store system 100. The cart terminal 400 is attached to a shopping cart C1 and installed in the store. The cart terminal 400 is used by the customer in the store. That is, the cart terminal 400 is an example of a terminal device belonging to a second type that is lent to the customer by the store.

The settlement server 500 performs a settlement process for online settlement in response to a settlement request via the communication network 700. The settlement server 500 may be adapted for only one of a plurality of types of settlement methods such as credit card settlement and electronic money settlement or may be adapted for a plurality of settlement methods. For example, an existing settlement server operated by a settlement agent, which is adapted for a plurality of settlement services including a plurality of settlement methods can be applied as the settlement server 500.

The electronic receipt server 600 provides a receipt showing a transaction result as an image or a web page. For example, an existing electronic receipt server that offers an electronic receipt service can be applied as the electronic receipt server 600.

For example, one of the Internet, a virtual private network (VPN), a local area network (LAN), a public communication network, a mobile communication network, or the like or an appropriate combination thereof can be used as the communication network 700. The communication network 700 typically uses a mobile communication network and the Internet or the VPN.

The schematic configuration of each store system 100 is the same. That is, in the store system 100, a store server 1, a virtual POS server 2, a mobile controller 3, a communication server 4, a payment machine 5, and an access point 6 are communicable with one another via the store communication network 7. However, the store server 1, the virtual POS server 2, the mobile controller 3, the communication server 4, the payment machine 5, the access point 6, and the store communication network 7 only need to have the same functions for realizing operations to be described later and does not need to be completely identical. Some store systems 100 may also include devices that are not shown in FIG. 1.

The store server 1 comprehensively manages a plurality of transactions to be processed by the transaction processing system 800. The store server 1 has, for example, functions similar to those of an existing POS server. The virtual POS server 2 is an information processing apparatus. Specifically, the virtual POS server 2 is a transaction processing apparatus that performs information processing (hereinafter, referred to as transaction process) for registering purchased commodities for each transaction and paying for the purchased commodities in response to a request from an external device. The virtual POS server 2 virtually realizes functions of an existing POS terminal. The information processing performed by the virtual POS server 2 is customized to accommodate a difference in operation policy of each store. That is, for example, the transaction process performed by the store server 1 provided in the store system 100A may be partially different from the transaction process performed by the store server 1 provided in the store system 100B.

The mobile controller 3 is an information processing apparatus. Specifically, the mobile controller 3 is a management processing apparatus that performs a management process and a mediation process. The management process is information processing for managing the transaction process performed by the virtual POS server 2. The mediation process is information processing for mediating the virtual POS server 2 and the user terminal 300 or the cart terminal 400 for the transaction process performed by the virtual POS server 2 in a case where the user terminal 300 or the cart terminal 400 is used as a user interface device. The communication server 4 performs a communication process for the store server 1, the virtual POS server 2, the mobile controller 3, and the payment machine 5 to exchange data with the relay server 200 and the like via the communication network 700.

The payment machine 5 determines an amount of money for the purchased commodities for each transaction managed by the virtual POS server 2, and performs a process for causing the customer to pay the amount of money. The settlement methods that the payment machine 5 can accept for such settlement may be all or some of well-known settlement methods such as cash settlement, credit card settlement, electronic money settlement, point settlement, code settlement (also called mobile settlement, smartphone settlement, or the like). The payment machine 5 may be operated by either a store employee or a customer. For example, a self-payment machine used in an existing semi-self-POS system can be used as the payment machine 5. The payment machine 5 may have a function of performing information processing for registering a commodity as a purchased commodity. In this case, for example, a face-to-face POS terminal used in an existing POS system or a self-POS terminal used in an existing self-POS system can be used as the payment machine 5.

The access point 6 performs a communication process for enabling the user terminal 300 and the cart terminal 400 to access the store communication network 7 by wireless communication. For example, a well-known communication device that performs wireless communication according to the IEEE802.11 standard can be used as the access point 6. The access point 6 is installed in the store such that the user terminal 300 and the cart terminal 400 can perform wireless communication anywhere in the store. Depending on the store size, a plurality of access points 6 may be arranged in one store system 100. For example, one of the Internet, a VPN, a LAN, a public communication network, a mobile communication network, or the like or an appropriate combination thereof can be used as the store communication network 7. Typically, the store communication network 7 is a LAN.

A two-dimensional code TC1 for check-in is posted near the entrance of the store provided with the store system 100 and a two-dimensional code TC2 for check-out is posted near the exit. The two-dimensional code TC1 indicates check-in data for check-in. The two-dimensional code TC2 indicates check-out data for check-out. The check-in data and the check-out data differ from store to store. Therefore, in a case where the two-dimensional codes TC1, TC2 for the store A needs to be distinguished from the two-dimensional codes TC1, TC2 for the store B, those for the store A will be referred to as two-dimensional codes TC1A, TC2A and those for the store B will be referred to as two-dimensional codes TC1B, TC2B.

The check-in data indicates, for example, the following information. (1) An operation version of the store system 100. For example, the check-in data indicated by the two-dimensional code TC1A indicates the operation version of the store system 100A. The check-in data indicated by the two-dimensional code TC1B indicates the operation version of the store system 100B. (2) A business operator code for identifying a business operator operating the store in which the store system 100 is provided. For example, the check-in data indicated by the two-dimensional code TC1A indicates the business operator code assigned to the business operator operating store A. The check-in data indicated by the two-dimensional code TC1B indicates the business operator code assigned to the business operator operating the store B. (3) A store code for identifying the store in which the store system 100 is provided. For example, the check-in data indicated by the two-dimensional code TC1A indicates the store code assigned to store A. The check-in data indicated by the two-dimensional code TC1B indicates the store code assigned to the store B. It should be noted that the store code may be capable of identifying each of all the stores using the transaction processing system 800 or may be capable of identifying each of a plurality of stores operated by the same business operator.

(4) The name of the business operator operating the store in which the store system 100 is provided. For example, the check-in data indicated by the two-dimensional code TC1A indicates the name of the business operator operating the store A. The check-in data indicated by the two-dimensional code TC1B indicates the name of the business operator operating the store B. (5) The name of the store in which the store system 100 is provided. For example, the check-in data indicated by the two-dimensional code TC1A indicates the name of the store A. The check-in data indicated by the two-dimensional code TC1B indicates the name of the store B. (6) A flag for distinguishing the two-dimensional code TC1 from the two-dimensional code TC2

The state of the flag in the check-in data indicates that it is check-in data. The state is, for example, “1”. The flag is common to all the two-dimensional codes TC1.

(7) An IP address of the communication server 4. For example, the check-in data indicated by the two-dimensional code TC1A indicates the IP address of the communication server 4 included in the store system 100A. The check-in data indicated by the two-dimensional code TC1B indicates the IP address of the communication server 4 included in the store system 100B. (8) A domain name of the relay server 200. The domain name is common to all the two-dimensional codes TC1. However, a plurality of relay servers 200 having different domain names may be used separately for each store. In this case, the check-in data indicated by the two-dimensional code TC1 indicates the domain name of the relay server 200 used in the corresponding store. (9) The address of the electronic receipt server 600. The address may be common to all the two-dimensional codes TC1 or any of a plurality of addresses may be indicated for each two-dimensional code TC1.

(10) A flag indicating whether the user terminal 300 should use wireless communication with the access point 6 or wireless communication with the communication network 700 for data exchange with the store system 100. For example, in a case where the wireless communication with the access point 6 is used for data exchange between the store system 100A and the user terminal 300 in the store A, the flag is set to “1”, for example. For example, in a case where the wireless communication with the communication network 700 is used for data exchange between the store system 100B and the user terminal 300 in the store B, the flag is set to “0”, for example. (11) A service set identifier (SSID) for identifying the access point 6. For example, the check-in data indicated by the two-dimensional code TC1A indicates the SSID for identifying the access point 6 included in the store system 100A. The check-in data indicated by the two-dimensional code TC1B indicates the SSID of the access point 6 included in the store system 100B. (12) A password for accessing the access point 6. For example, the check-in data indicated by the two-dimensional code TC1A indicates the password set in the access point 6 included in the store system 100A. The check-in data indicated by the two-dimensional code TC1B indicates the password set in the access point 6 included in the store system 100B.

(13) An identification number of a security system used by the access point 6. For example, “1” is assigned to a WPA2-PSK system, “2” is assigned to a WPA-PSK system, and “3” is assigned to a WEP system. For example, in a case where the access point 6 included in the store system 100A uses the WPA2-PSK system as the security system, the check-in data indicated by the two-dimensional code TC1A indicates “1” as the identification number. Further, for example, in a case where the access point 6 included in the store system 100B uses the WPA-PSK method as the security system, the check-in data indicated by the two-dimensional code TC1B indicates “2” as the identification number. (14) A flag for identifying whether to conclude an error when the user terminal 300 fails to connect to the relay server 200 or to continue the operation without concluding an error. For example, in a case where a setting to conclude an error when the user terminal 300 fails to connect to the relay server 200 is employed in the store A, the check-in data indicated by the two-dimensional code TC1A indicates, for example, “1” as the flag. Further, for example, in a case where a setting to continue the operation even in a case where the user terminal 300 fails to connect to the relay server 200 is employed in the store B, the check-in data indicated by the two-dimensional code TC1B indicates, for example, “0” as the flag.

(15) An identification number of a transmission mode related to a status of the user terminal 300. The transmission mode includes, for example, a first mode, a second mode, and a third mode. For example, “1” is assigned to the first mode, “2” is assigned to the second mode, and “3” is assigned to the third mode as the identification number of the transmission mode. On the first mode, the status of the user terminal 300 is transmitted to the relay server 200. On the second mode, the status of the user terminal 300 is transmitted to the store system 100. On the third mode, the status of the user terminal 300 is not transmitted. For example, in a case where the first mode is applied as the transmission mode in the store A, the check-in data indicated by the two-dimensional code TC1A indicates “1” as the ID number. For example, in a case where the second mode is applied as the transmission mode in the store B, the check-in data indicated by the two-dimensional code TC1B indicates “2” as the ID number.

(16) An identification number of a transmission mode related to a log file storing log data of the user terminal 300. The transmission mode includes, for example, a first mode, a second mode, a third mode, and a fourth mode. For example, “1” is assigned to the first mode, “2” is assigned to the second mode, “3” is assigned to the third mode, and “4” is assigned to the fourth mode as the identification number of the transmission mode. On the first mode, the log file is transmitted only to the relay server 200. On the second mode, the log file is transmitted only to the store system 100. On the third mode, the log file is transmitted to both the store system 100 and the relay server 200. On the fourth mode, the log file is not transmitted. For example, in a case where the first mode is applied as the transmission mode in the store A, the check-in data indicated by the two-dimensional code TC1A indicates “1” as the ID number. For example, in a case where the second mode is applied as the transmission mode in the store B, the check-in data indicated by the two-dimensional code TC1B indicates “2” as the ID number.

(17) A host name or IP address used when transmitting the log file in accordance with a file transfer protocol (FTP) to the relay server 200 via the communication network 700. (18) A user name used when transmitting the log file in accordance with the FTP to the relay server 200 via the communication network 700. (19) A password used when transmitting the log file in accordance with the FTP to the relay server 200 via the communication network 700. (20) A path name of the log file to be transmitted in accordance with the FTP to the relay server 200 via the communication network 700.

(21) A flag for identifying whether or not to delete check digits of a universal product code (UPC) which is a kind of commodity code. For example, in a case where the operation not to delete the check digits is employed in the store A, the check-in data indicated by the two-dimensional code TC1A indicates, for example, “1” as the flag. Further, for example, in a case where the operation to delete the check digits is employed in the store B, the check-in data indicated by the two-dimensional code TC1B indicates, for example, “0” as the flag. (22) A time until the camera screen is automatically shift in the user terminal 300. The check-in data indicated by the two-dimensional code TC1A indicates a time preset for the store A as the time. The check-in data indicated by the two-dimensional code TC1B indicates a time preset for the store B as the time. (23) A timeout time when the user terminal 300 communicates with the store system 100 via the access point 6. The check-in data indicated by the two-dimensional code TC1A indicates a time preset for the store A as the time. The check-in data indicated by the two-dimensional code TC1B indicates a time preset for the store B as the time.

(24) The allowable number of retries when the communication between the user terminal 300 and the store system 100 via the access point 6 times out. The check-in data indicated by the two-dimensional code TC1A indicates the number of retries preset for the store A as the number of retries. The check-in data indicated by the two-dimensional code TC1B indicates the number of retries preset for the store B as the number of retries. (25) A timeout time when the user terminal 300 communicates with the store system 100 via the relay server 200. The check-in data indicated by the two-dimensional code TC1A indicates a time preset for the store A as the time. The check-in data indicated by the two-dimensional code TC1B indicates a time preset for the store B as the time. (26) The allowable number of retries when the communication between the user terminal 300 and the store system 100 via the relay server 200 times out. The check-in data indicated by the two-dimensional code TC1A indicates the number of retries preset for the store A as the number of retries. The check-in data indicated by the two-dimensional code TC1B indicates the number of retries preset for the store B as the number of retries.

(27) Authentication data used in a certification process for authenticating a declaration of completion of confirmation related to a transaction with respect to a commodity that requires confirmation by the store employee. The check-in data indicated by the two-dimensional code TC1A indicates the authentication data preset for the store A. The check-in data indicated by the two-dimensional code TC1B indicates the authentication data preset for the store B. The authentication data is favorably determined to be different for each store, but the same authentication data may be set for different stores. (28) Data for identifying an operation mode of the store system 100. For example, in a case where the store system 100A is set to be on a normal mode to normally operate the transaction processing system 800, the check-in data indicated by the two-dimensional code TC1A indicates, for example, “1” as the data. Further, for example, in a case where the store system 100B is set to be on a demonstration mode to demonstrate the transaction processing system 800, the check-in data indicated by the two-dimensional code TC1B indicates, for example, “2” as the data. (29) Data for identifying the mode of data transfer to the payment machine 5. For example, in a case where the store system 100A is set to be on a mode on which the payment machine 5 requests the mobile controller 3 to transfer data, the check-in data indicated by the two-dimensional code TC1A indicates, for example, “1” as the data. Further, for example, in a case where the store system 100B is set to be on a mode on which data is transferred from the mobile controller 3 to the payment machine 5 without a request from the payment machine 5, the check-in data indicated by the two-dimensional code TC1B indicates, for example, “2” as the data.

(30) A flag indicating whether or not settlement as the code settlement through an operation of the user terminal 300 is permitted. For example, in a case where the code settlement is permitted in the store A, the check-in data indicated by the two-dimensional code TC1A indicates, for example, “1” as the flag. Further, for example, in a case where the code settlement is not permitted in the store B, the check-in data indicated by the two-dimensional code TC1B indicates, for example, “0” as the flag. (31) A flag for identifying whether or not registration of an age-restricted product for which the age restriction of a purchaser is defined through the user terminal 300 is permitted. For example, in a case where the registration of the age-restricted product through the user terminal 300 is permitted in the store A, the check-in data indicated by the two-dimensional code TC1A indicates, for example, “1” as the flag. Further, for example, in a case where the registration of the age-restricted product through the user terminal 300 is not permitted in the store B, the check-in data indicated by the two-dimensional code TC1B indicates, for example, “0” as the flag. (32) Data for identifying an input mode of a membership code of a point member. For example, in a case where the store system 100A is set to be on a mode to manually input the membership code, the check-in data indicated by the two-dimensional code TC1A indicates, for example, “1” as the data. Further, for example, in a case where the store system 100B is set to be on a mode to input the membership code by reading a barcode, the check-in data indicated by the two-dimensional code TC1B indicates, for example, “2” as the data.

(33) A flag for identifying whether or not confirmation by the store employee is required for inputting the membership code in a case where the mode to manually input the membership code of the point member is set. For example, in a case where the confirmation is required at the store A, the check-in data indicated by the two-dimensional code TC1A indicates, for example, “1” as the flag. Further, for example, in a case where the confirmation is not required in the store B, the check-in data indicated by the two-dimensional code TC1B indicates, for example, “0” as the flag. (34) A threshold for checking a remaining battery level of the user terminal 300 during check-in. The threshold is set for each store or for each business operator. For example, in a case where the business operator operating the store A sets the threshold to “20%”, the check-in data indicated by the two-dimensional code TC1A indicates, for example, “20” as the threshold. For example, in a case where the store B sets the threshold to “25%”, the check-in data indicated by the two-dimensional code TC1B indicates, for example, “25” as the threshold. The above is an example of the information indicated by the check-in data. However, the check-in data does not need to include some of the various types of information described above. Further, the check-in data may indicate information different from the various types of information described above.

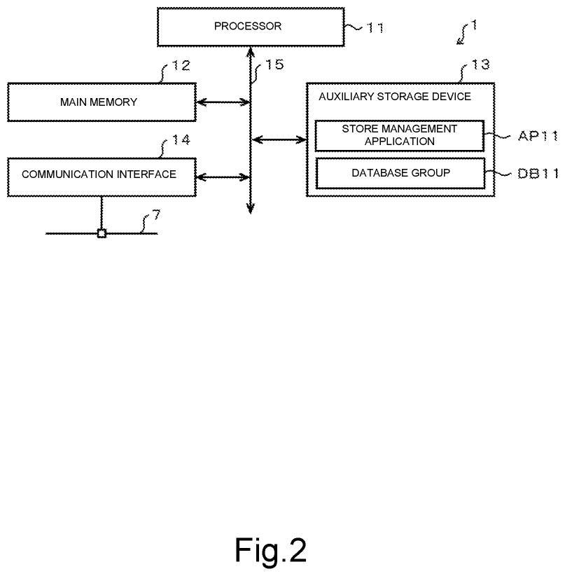

FIG. 2 is a block diagram showing a circuit configuration of the store server 1. The store server 1 includes a processor 11, a main memory 12, an auxiliary storage device 13, a communication interface 14, and a transmission path 15. The processor 11, the main memory 12, the auxiliary storage device 13, and the communication interface 14 are communicable with one another via the transmission path 15. The processor 11, the main memory 12, and the auxiliary storage device 13 are connected through the transmission path 15 to configure a computer for controlling the store server 1.

The processor 11 corresponds to a central portion of the computer. The processor 11 performs information processing for realizing various functions as the store server 1 in accordance with information processing programs such as an operating system and an application program. The processor 11 is, for example, a central processing unit (CPU).

The main memory 12 corresponds to a main storage portion of the computer. The main memory 12 includes a non-volatile memory area and a volatile memory area. The main memory 12 stores the above-mentioned information processing programs in the non-volatile memory area. The main memory 12 may store data necessary for the processor 11 to perform the information processing in the non-volatile or volatile memory area. The volatile memory area of the main memory 12 is used as a work area in which data is rewritten by the processor 11 as appropriate. The non-volatile memory area is, for example, a read only memory (ROM). The volatile memory area is, for example, a random access memory (RAM).

The auxiliary storage device 13 corresponds to an auxiliary storage portion of the computer. For example, a storage unit using a well-known storage device such as an electric erasable programmable read-only memory (EEPROM), a hard disc drive (HDD), and a solid state drive (SSD) can be used as the auxiliary storage device 13. The auxiliary storage device 13 stores data used by the processor 11 to perform various processes, data generated by processing in the processor 11, and the like. The auxiliary storage device 13 may store the information processing programs.

The communication interface 14 performs data communication with each unit connected to the store communication network 7 in accordance with a predetermined communication protocol. For example, a well-known communication device for the LAN can be applied as the communication interface 14. The transmission path 15 includes an address bus, a data bus, a control signal line, and the like, and transmits data and control signals exchanged between the connected units.

The auxiliary storage device 13 stores a store management application AP11 which is one of the information processing programs. The store management application AP11 is an application program and describes the information processing for realizing the functions as the store server 1. The store management application AP11 may be a separate one generated in accordance with the store management policy of each store or each business operator operating the store. For example, in a case where the method of managing sales data differs between the store A and the store B, the store management application AP11 used in the store system 100A describes information processing for management of the sales data conforming to the method of managing the sales data in the store A. Further, the store management application AP11 used in the store system 100B describes information processing for management of sales data conforming to the method of managing the sales data in the store B.

A portion of the storage area of the auxiliary storage device 13 is used as a database group DB11. The database group DB11 includes a plurality of databases for various types of information management. One of the databases included in the database group DB11 is a commodity database for managing commodities sold in the store. A commodity database is a set of data records associated with commodities to be managed. The data record of the commodity database includes data related to the associated commodity, such as a commodity code, a price, and a commodity name. The commodity code is an identification code set for identifying commodities for each stock keeping unit (SKU), and, for example, a Japanese article number (JAN) code is used. The commodity name is a name set such that a person can easily distinguish the commodity from the others. The price is an amount of money for purchasing the commodity.

One of the databases included in the database group DB11 is a user database for managing store users. The user database is a set of data records associated with customers registered as the store users. The data record of the user database includes data related to the associated customer, such as a user code and attribute information for identifying the user. The user code is a unique identification code set for each store user in order to individually identify the store user. The attribute information may include name, gender, age, address, telephone number, and the like. The data record in the user database may also include settlement information declared by the store user. The settlement information includes a credit number, a code settlement identifier (ID), and the like. In a case where a plurality of settlement methods can be selected, the settlement information may include a settlement method code for identifying the settlement method. Further, in the case of a store offering a point (reward) service, the data record of the user database may include an identifier (hereinafter, referred to as point ID) for identifying the user of the point service, held points, and the like. Further, the data record of the user database may include a user identifier (hereinafter, referred to as electronic receipt ID) for identifying a user of the electronic receipt service. The various types of data included in the data records of the user database do not need to include substantial data for all users. For example, regarding the point ID or the electronic receipt ID, the user database may include only the point ID or the electronic receipt ID for which the user has applied for registration in advance.

In addition, the database group DB11 may include a variety of databases like those managed by a POS server in the existing POS system. It should be noted that what type of database the database group DB11 includes or what type of data those databases include may be determined for each store.

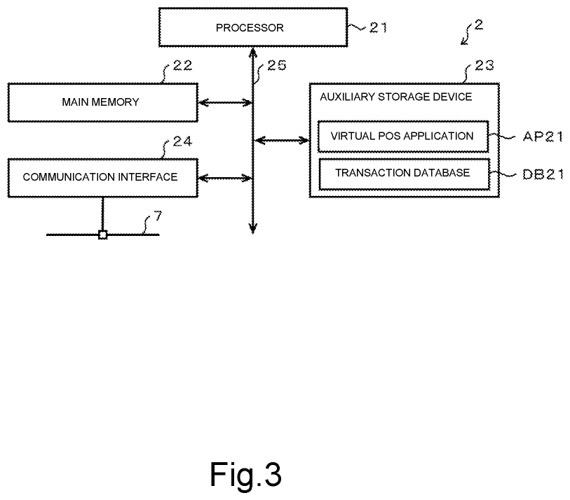

FIG. 3 is a block diagram showing a circuit configuration of the virtual POS server 2. The virtual POS server 2 includes a processor 21, a main memory 22, an auxiliary storage device 23, a communication interface 24, and a transmission path 25. The processor 21, the main memory 22, the auxiliary storage device 23, and the communication interface 24 are communicable with one another via the transmission path 25. The processor 21, the main memory 22, and the auxiliary storage device 23 are connected through the transmission path 25 to configure a computer for controlling the virtual POS server 2. It should be noted that schematic functions of the processor 21, the main memory 22, the auxiliary storage device 23, the communication interface 24, and the transmission path 25 is similar to those of the processor 11, the main memory 12, the auxiliary storage device 13, the communication interface 14, and the transmission path 15, and thus descriptions thereof will be omitted.

It should be noted that the auxiliary storage device 23 stores a virtual POS application AP21 instead of the store management application AP11. The virtual POS application AP21 is an application program and describes a transaction process. The virtual POS application AP21 may be a separate one generated in accordance with the store management policy of each store or each business operator operating the store. For example, in a case where the store A offers a discount service that is not offered by the store B, the virtual POS application AP21 used in the store system 100A describes information processing for realizing the discount service. Further, the virtual POS application AP21 used in the store system 100B does not describe information processing for realizing the discount service.

Further, a portion of the storage area of the auxiliary storage device 23 is used as a transaction database DB21 instead of the database group DB11. The transaction database DB21 is a set of data records associated with transactions with customers shopping in the store. The data record of the transaction database DB21 includes a transaction code and commodity data related to a commodity registered as a purchased commodity. The transaction code is a unique identification code set for each transaction for identifying each transaction. The commodity data indicates a commodity code, a commodity name, a price, the number of commodities (quantity), and the like. The structure of the transaction database DB21 may be individually determined in accordance with the store management policy of each store or each business operator operating the store.

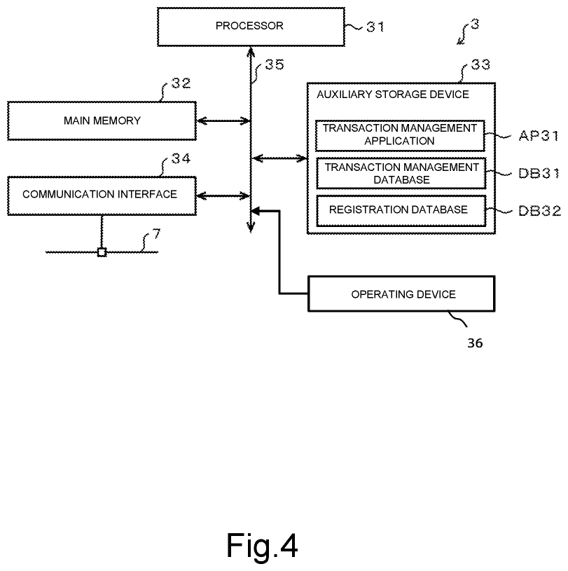

FIG. 4 is a block diagram showing a circuit configuration of the mobile controller 3. The mobile controller 3 includes a processor 31, a communication interface 34, an operating device 36, and a transmission path 35. The mobile controller 3 further includes a main memory 32 and an auxiliary storage device 33 as storage devices. The processor 31, the main memory 32, the auxiliary storage device 33, and the communication interface 34 are communicable with one another via a transmission path 35. The processor 31, the main memory 32, and the auxiliary storage device 33 are connected through the transmission path to configure a computer for controlling the mobile controller 3. It should be noted that schematic functions of the processor 31, the main memory 32, the auxiliary storage device 33, the communication interface 34, and the transmission path 35 are similar to those of the processor 11, the main memory 12, the auxiliary storage device 13, the communication interface 14, and the transmission path 15, and thus descriptions thereof will be omitted.

It should be noted that the auxiliary storage device 33 stores a transaction management application AP31 instead of the store management application AP11. The transaction management application AP31 is an application program and describes a management process and a mediation process. The transaction management application AP31 is common to the respective store systems 100. However, various settings for information processing based on the transaction management application AP31 may be customized for each store system 100.

Further, a portion of the storage area of the auxiliary storage device 23 is used as a transaction management database DB31 and a registration database DB32 instead of the database group DB11. The structures of the transaction management database DB31 and the registration database DB32 are common to the respective store systems 100.

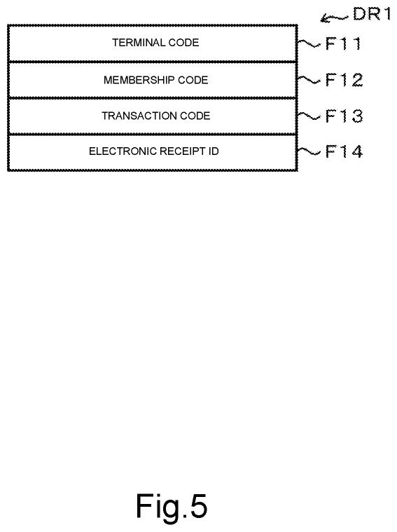

FIG. 5 is a schematic diagram showing a data structure of a data record DR1 included in the transaction management database DB31. The transaction management database DB31 is a set of data records DR1 associated with the user terminal 300 or cart terminal 400 used by customers in the store. Therefore, when there is only one customer in the store, the transaction management database DB31 includes one data record DR1. When there are no customers in the store, the transaction management database DB31 includes no data records DR1. The data record DR1 includes fields F11, F12, F13, F14.

The field F11 is set with a terminal code in order to identify the associated user terminal 300 or cart terminal 400. For example, a unique identification code set for each communication terminal in order to identify each communication terminal used as the user terminal 300 or the cart terminal 400 can be used as the terminal code. Alternatively, for example, an identification code set for a smartphone POS application or cart terminal application to be described later when installing the smartphone POS application or cart terminal application in the user terminal 300 or cart terminal 400 can be used as the terminal code. The field F12 is set with a membership code for identifying the customer using the associated user terminal 300 or cart terminal 400 from other customers. The field F13 is set with the transaction code of a transaction performed by using the associated user terminal 300 or cart terminal 400. The field F14 is set with the electronic receipt ID, as necessary. It should be noted that the data record DR1 may include another field which is set with data different from the fields F11 to F14.

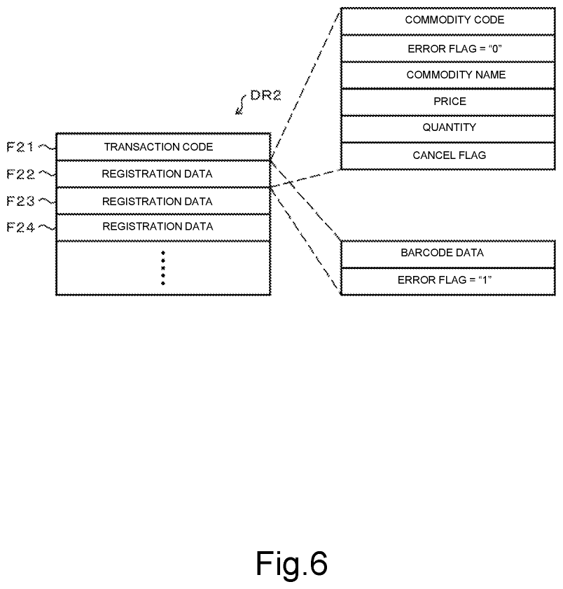

FIG. 6 is a schematic diagram showing a data structure of a data record DR2 included in the registration database DB32. The registration database DB32 is a set of data records DR2 associated with transactions with customers shopping in the store. The data record DR2 includes fields F21 and F22. The data record DR1 can further include fields F23, F24, . . . .

The field F21 is set with the transaction code of the associated transaction. The transaction code is identical to the transaction code set in field F12 of the data record DR1 associated with user terminal 300 used in the associated transaction. The field F22 is set with registration data for commodity registration attempted for the associated transaction. The registration data will be described later.

The data record DR2 includes fields subsequent to the field F22 in a case where two or more purchased commodities are attempted to be registered for the associated transaction. Registration data similar to that of the field F22 is set in the fields subsequent to the field F22.

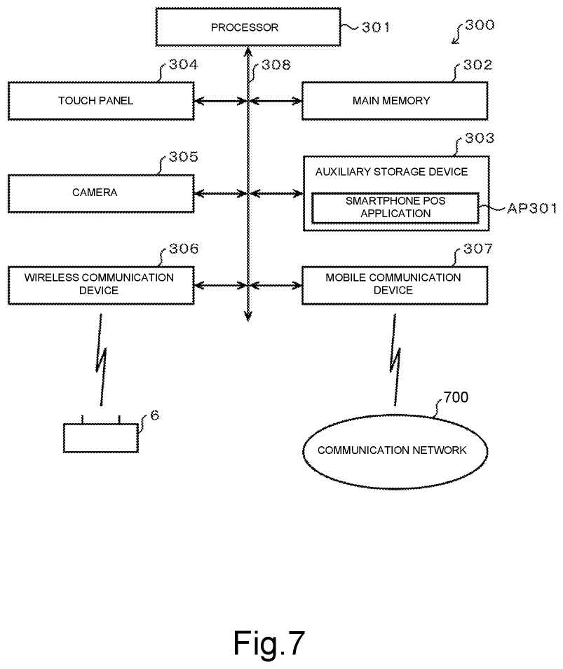

FIG. 7 is a block diagram showing a circuit configuration of the user terminal 300. The user terminal 300 includes a processor 301, a main memory 302, an auxiliary storage device 303, a touch panel 304, a camera 305, a wireless communication device 306, a mobile communication device 307, a transmission path 308, and the like. The processor 301, the main memory 302, the auxiliary storage device 303, the touch panel 304, the camera 305, and the mobile communication device 307 are communicable with one another via the transmission path 308. The processor 301, the main memory 302, and the auxiliary storage device 303 are connected through the transmission path 308 to configure a computer for controlling the user terminal 300. It should be noted that schematic functions of the processor 301, the main memory 302, the auxiliary storage device 303, and the transmission path 308 are similar to those of the processor 11, the main memory 12, the auxiliary storage device 13, and the transmission path 15, and thus descriptions thereof will be omitted.

The touch panel 304 functions as an input device and a display device of the user terminal 300. The camera 305 includes an optical system and an image sensor and generates, through the image sensor, image data representing an image in a field of view formed by the optical system.

The wireless communication device 306 exchanges data with the access point 6 by wireless communication according to a wireless communication protocol. For example, a well-known communication device according to the IEEE802.11 standard can be used as the wireless communication device 306. The mobile communication device 307 is an interface for data communication via the communication network 700. For example, a well-known communication device for performing data communication via a mobile communication network can be used as the mobile communication device 307.

It should be noted that the auxiliary storage device 303 stores a smartphone POS application AP301 which is one of the information processing programs. The smartphone POS application AP301 is an application program and describes information processing (hereinafter, referred to as smartphone UI process) to be described later for causing the user terminal 300 to function as a user interface of the store system 100. The smartphone POS application AP301 is commonly used by a plurality of user terminals 300.

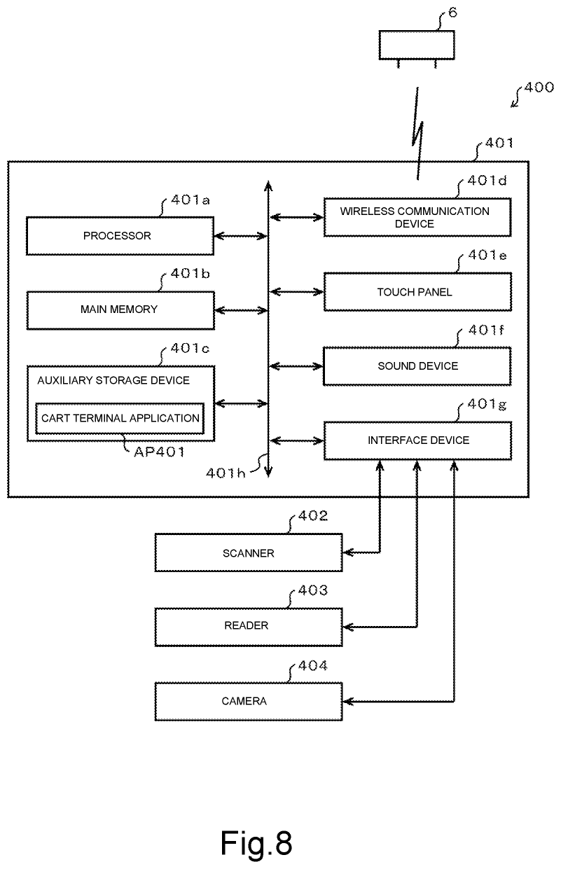

FIG. 8 is a block diagram showing a circuit configuration of the cart terminal 400. The cart terminal 400 includes a tablet computer 401, a scanner 402, a reader 403, and a camera 404.

The tablet computer 401 includes a processor 401a, a main memory 401b, an auxiliary storage device 401c, a wireless communication device 401d, a touch panel 401e, a sound device 401f, an interface device 401g, and a transmission path 401h. The processor 401a, the main memory 401b, the auxiliary storage device 401c, the wireless communication device 401d, the touch panel 401e, the sound device 401f, and the interface device 401g are communicable with one another via the transmission path 401h. The processor 401a, the main memory 401b, and the auxiliary storage device 401c are connected through the transmission path 401h to configure a computer for controlling the cart terminal 400. It should be noted that schematic functions of the processor 401a, the main memory 401b, the auxiliary storage device 401c, the touch panel 401e, the wireless communication device 401d, and the transmission path 401h are similar to those of the processor 11, the main memory 12, the auxiliary storage device 13, the touch panel 304, the wireless communication device 306, and the transmission path 15, and thus descriptions thereof will be omitted.

It should be noted that the auxiliary storage device 401c stores a cart terminal application AP401 instead of the store management application AP11. The cart terminal application AP401 is an application program and describes information processing (hereinafter, referred to as cart UI process) to be described later for causing the cart terminal 400 to function as the user interface of the store system 100. The cart terminal application AP401 is commonly used by a plurality of cart terminals 400.

The sound device 401f outputs various sounds such as voice and melody. The scanner 402, the reader 403, and the camera 404 are connected to the interface device 401g. The interface device 401g function as an interface for data exchange between the scanner 402, the reader 403, and the camera 404 and the processor 401a. An existing universal serial bus (USB) controller or the like can be used as the interface device 401g.

The scanner 402 reads a code symbol such as a barcode and a two-dimensional data code. The scanner 402 mainly reads a code symbol attached to a commodity and indicating the commodity code and the like of the commodity. The scanner 402 may be shown on a membership card or displayed on a mobile terminal and used to read a code symbol indicating the membership code and the like. The scanner 402 outputs data indicated by the read code symbol. The scanner 402 may be of a type that reads the code symbol by scanning with a laser beam, or may be of a type that reads the code symbol from an image picked up by an image pickup device.

The reader 403 reads and outputs data recorded on a recording medium. The reader 403 is a magnetic card reader in a case where the recording medium is a magnetic card, and is an IC card reader in a case where the recording medium is a contact type IC card. In a case of a recording medium using radio frequency identification (RFID) such as a contactless IC card and a smartphone, an RFID reader is used as the reader 403. The camera 404 captures an image of an overhead view of a shopping basket placed on the shopping cart C1. The camera 404 outputs image data representing the captured image.

For example, a general-purpose server device can be used as a hardware of the store server 1, the virtual POS server 2, or the mobile controller 3. The store server 1, the virtual POS server 2, or the mobile controller 3 is generally transferred in a state in which the store management application AP11, the virtual POS application AP21, or the transaction management application AP31 is stored in the auxiliary storage device 13, 23, or 33, and the database group DB11, the transaction database DB21, or the transaction management database DB31 and the registration database DB32 are not stored. However, hardware in a state in which the store management application AP11, the virtual POS application AP21, or the transaction management application AP31 is not stored in the auxiliary storage device 13, 23, or or in a state in which the same type of application program in another version is stored in the auxiliary storage device 13, 23, or 33 and the store management application AP11, the virtual POS application AP21, or the transaction management application AP31 may be individually transferred. The store server 1, the virtual POS server 2, or the mobile controller 3 may be configured by writing the store management application AP11, the virtual POS application AP21, or the transaction management application AP31 in the auxiliary storage device 13, 23, or 33 in accordance with an operation of an arbitrary operator. The store management application AP11, the virtual POS application AP21, or the transaction management application AP31 can be transferred by recording on a removable recording medium such as a magnetic disk, a magneto-optical disc, an optical disc, and a semiconductor memory or by communication via a network. The transaction database DB21, or the transaction management database DB31, and the registration database DB32 are stored in the auxiliary storage device 13, 23, or 33 by the processor 11, 21, or 31 performing information processing based on the store management application AP11, the virtual POS application AP21, or the transaction management application AP31. It should be noted that at least part of the store management application AP11 and the databases included in the database group DB11 may be stored in the main memory 12. At least part of the virtual POS application AP21 and the transaction database DB21 may be stored in the main memory 22. At least part of the transaction management application AP31, the transaction management database DB31, and the registration database DB32 may be stored in the main memory 32.

Next, an operation of the transaction processing system 800 will be described. It should be noted that the various processes described below are only examples, and it is possible to change the order of some processes, omit some processes, or add other processes as appropriate. For example, descriptions of some processes will be omitted hereinafter for the sake of easy understanding of characteristic operations according to the embodiment. For example, in a case where an error occurs, a process for coping with the error may be performed, but a description of part of such a process will be omitted.

In the following description, a service offered by the operation of the transaction processing system 800 to the customer using the user terminal 300 will be referred to as a smartphone POS service. A service offered by the operation of the transaction processing system 800 to the customer using the cart terminal 400 will be referred to as a cart POS service. The user terminal 300 exchanges data with the store system 100 in order to use the smartphone POS service. Whether the wireless communication with the access point 6 and the wireless communication with the communication network 700 are used for such communication depends on the state of the flag included in the check-in data. However, for the sake of simplicity of description, a case where the wireless communication with the access point 6 is used will be described hereinafter. Whether the mode on which the payment machine 5 requests the mobile controller 3 to transfer data or the mode on which data is transferred from the mobile controller 3 to the payment machine 5 without a request from the payment machine 5 is used for data transfer from the virtual POS server 2 to the payment machine 5 for performing payment through the payment machine 5 depends on the state of the flag included in the check-in data. However, for the sake of simplicity of description, the description will be given hereinafter, assuming that the mode on which the payment machine 5 requests the mobile controller 3 to transfer data is constantly used.

In order to use the smartphone POS service, the customer installs the smartphone POS application AP301 in the smartphone or the like owned by the customer and makes it usable as the user terminal 300. Alternatively, the customer rents the user terminal 300 that is a tablet terminal or the like in which the smartphone POS application AP301 is installed at the store. Then, the customer enters any store in which the store system 100 is provided with the user terminal 300 in which the information processing based on the smartphone POS application AP301 is activated.

In a case where the customer wishes to check the result of the transaction using the smartphone POS service by the electronic receipt service, the customer performs registration for the use of the electronic receipt service. The electronic receipt ID is assigned to the customer in such use registration. The customer causes the user terminal 300 owned by the customer to store the electronic receipt ID assigned to the customer. Further, the electronic receipt ID may be stored in association with the point ID in a membership database managed by the store in order to manage the customers. In this case, the customer may cause the user terminal 300 owned by the customer to store the point ID assigned to the customer.

In the user terminal 300, the processor 301 obtains the electronic receipt ID or the point ID by a setting process based on the smartphone POS application AP301, and stores the electronic receipt ID or the point ID in the auxiliary storage device 303 as registration data related to the smartphone POS application AP301. For example, when the operator requests to register the electronic receipt ID, the processor 301 causes the operator to designate a login ID and a login password for authenticating the user in the electronic receipt server 600. The processor 301 logs in to the electronic receipt server 600 by using the designated login ID and login password, obtains the electronic receipt ID of the user identified by the login ID, and stores the electronic receipt ID in the auxiliary storage device 303. The processor 301 may, for example, cause the operator to designate the electronic receipt ID and store the designated electronic receipt ID in the auxiliary storage device 303. For example, when the operator requests to register the point ID, the processor 301 causes the operator to designate the point ID and stores the designated point ID in the auxiliary storage device 303. It should be noted that a point card number or the like assigned to a point card distributed to the customer is used as the point ID. In a case where the registration of the electronic receipt ID and the point ID is sequentially requested, the processor 301 performs the above-mentioned processes individually and stores both the electronic receipt ID and the point ID in the auxiliary storage device 303. However, the processor 301 may store only predetermined one of them.

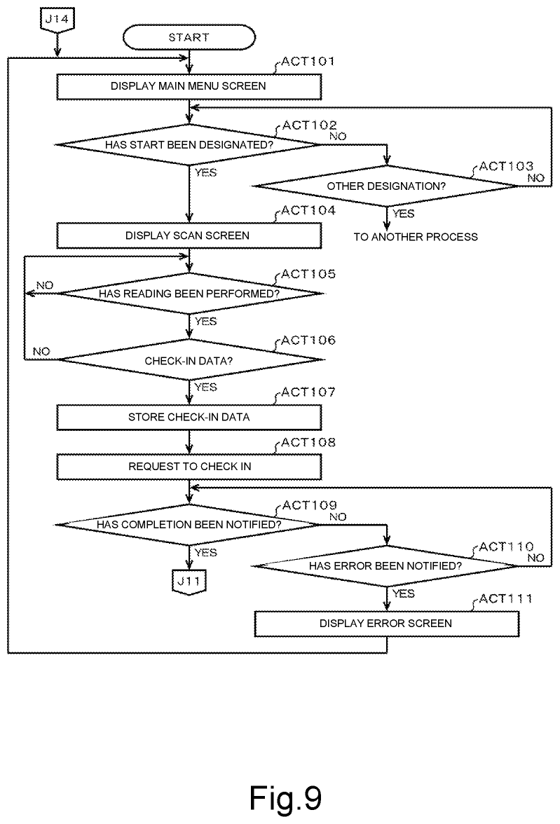

FIGS. 9, 10, 11, and 12 are flowcharts each showing the smartphone UI process performed by the processor 301 of the user terminal 300 in accordance with the smartphone POS application AP301. First, in ACT101 shown in FIG. 9, the processor 301 displays a main menu screen on the touch panel 304. The main menu screen is a screen for receiving designation of any of several types of processes to be performed in accordance with the smartphone POS application AP301. The main menu screen includes a plurality of GUI (graphical user interface) elements, including a GUI element for designating the shopping start. It should be noted that the GUI element is, for example, a soft key.

In ACT102, the processor 301 determines whether the shopping start has been designated. In a case where it is determined that the shopping start has not been designated (NO in ACT102), the processing of the processor 301 proceeds to ACT103. In ACT103, the processor 301 determines whether or not designation other than designation of the shopping start has been made. In a case where it is determined that the designation other than designation of the shopping start has not been made (NO in ACT103), the processing of the processor 301 returns to ACT102. The processor 301 thus waits for some designation on the main menu screen to be made in ACT102 and ACT103. In a case where it is determined that the designation other than the designation of the shopping start has been made (YES in ACT103), the processing of the processor 301 proceeds to the designated process. It should be noted that a description of the processing of the processor 301 in this case will be omitted. The processing of the processor 301 for registering the electronic receipt ID or the point ID described above may form part of the process here.

When the customer enters the store and starts shopping, the customer performs a predetermined operation for designating the shopping start on the main menu screen. When the operation is detected by the touch panel 304 for example, the processor 301 determines that the shopping start has been designated. In a case where it is determined that the shopping start has been designated (YES in ACT102), the processing of the processor 301 proceeds to ACT104. In ACT104, the processor 301 displays a scan screen for check-in on the touch panel 304. The scan screen for check-in is a screen for prompting the customer to read the two-dimensional code TC1 for check-in. The processor 301, for example, activates the camera 305 and generates the scan screen by superimposing a character message prompting the customer to read the two-dimensional code TC1 and a line indicating a position to which the two-dimensional code TC1 should be made to face on the image thus obtained by the camera 305.

When the scan screen is displayed on the touch panel 304, the customer directs the camera 305 to the two-dimensional code TC1 such that the two-dimensional code TC1 posted near the entrance of the store is reflected on the scan screen.

In ACT105, the processor 301 waits for the two-dimensional code to be read while determining whether or not the two-dimensional code has been read. At this time, the processor 301 repeatedly analyzes the image obtained by the camera 305 and attempts to read the two-dimensional code. The reading of the two-dimensional code may be performed as a process based on the smartphone POS application AP301 or may be read as a process based on another application program for reading the two-dimensional code. In a case where it is determined that the two-dimensional code has been read (YES in ACT105), the processing of the processor 301 proceeds to ACT106.

In ACT106, the processor 301 determines whether or not data indicated by the read two-dimensional code is the check-in data. In a case where it is determined that the data is not the check-in data (NO in ACT106), the processing of the processor 301 returns to ACT105. At this time, the processor 301 may cause the touch panel 304 to display a screen for notifying the customer that an erroneous two-dimensional code has been read.

In a case where the processor 301 determines that the data indicated by the read two-dimensional code is the check-in data (YES in ACT106), the processing of the processor 301 proceeds to ACT107. In ACT107, the processor 301 stores the read check-in data in the main memory 302 or in the auxiliary storage device 303.

In ACT108, the processor 301 requests the mobile controller 3 to check in. Specifically, the processor 301 establishes wireless communication between the wireless communication device 306 and the access point 6 on the basis of the data indicated by the check-in data. For example, when the camera 305 is directed by the customer to the two-dimensional code TC1A in the store A, the processor 301 establishes wireless communication with the access point 6 provided in the store system 100A on the basis of the check-in data indicated by the two-dimensional code TC1A. The processor 301 transmits request data for requesting check-in to the mobile controller 3 by wireless communication with the access point 6. When the wireless communication with the access point 6 provided in the store system 100A is established as described above, the request data is transmitted to the mobile controller 3 provided in the store system 100A via the access point 6 and the store communication network 7 provided in the store system 100A. It should be noted that the processor 301 includes identification data for identifying the check-in request and a terminal code in the request data for requesting check-in. In a case where the customer is a registered user of the smartphone POS service and has the membership code, the processor 301 also includes the membership code in the request data. The membership code is stored in the auxiliary storage device 303 of the user terminal 300, for example. In a case where the point ID is stored in auxiliary storage device 303, the processor 301 also includes the point ID in the request data. The processor 301 may include other data in the request data such as data for authenticating the customer, for example.

It should be noted that various requests from the user terminal 300 to the mobile controller 3 to be described later are realized by transmitting request data including identification data for identifying the type of request from the user terminal 300 to the mobile controller 3 via the access point 6 and the store communication network 7 as described above.

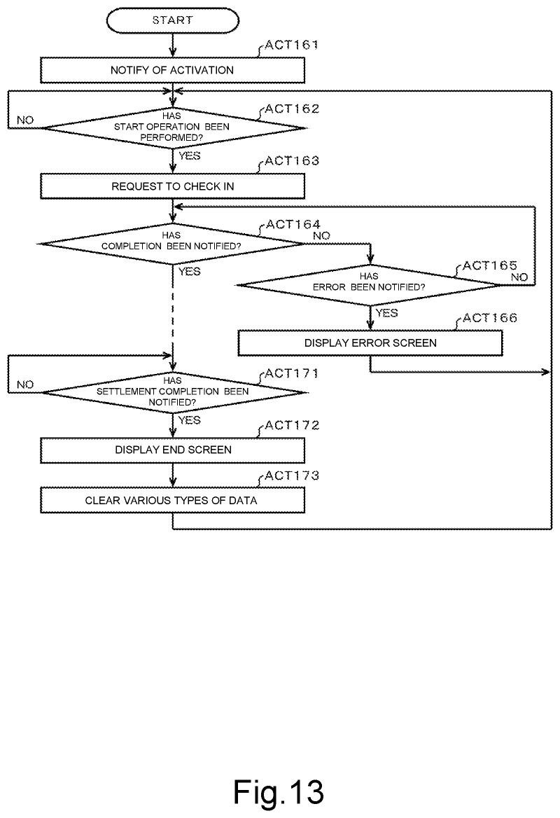

When the cart terminal 400 is activated, the processor 401a of the cart terminal 400 performs the cart UI process to be described below in accordance with the cart terminal application AP401. FIG. 13 is a flowchart showing the cart UI process performed by the processor 401a.

In ACT161 of FIG. 13, the processor 401a notifies the mobile controller 3 that the cart terminal 400 has been activated. Specifically, the processor 401a transmits notification data for activation notification to the mobile controller 3 by wireless communication between the wireless communication device 401d and the access point 6. The notification data is transmitted to the mobile controller 3 via the access point 6 and the store communication network 7. In ACT162, the processor 401a waits for a use start operation to be performed while determining whether or not the use start operation has been performed. At this time, the processor 401a waits for shopping using the shopping cart C1 to which the cart terminal 400 including the processor 401a has been attached to start. For example, the processor 401a displays a screen including a start button on the touch panel 401e under the standby state. For using the cart POS service, the customer takes out one of the shopping carts C1 placed in the cart storage place and performs a predetermined operation for starting the use on the cart terminal 400 attached to the shopping cart C1. In a case where the customer is a member, the customer causes the scanner 402 or the reader 403 to read the membership code recorded on the membership card. In a case where the customer is not a member, the customer operates the start button. When such an operation is performed, the processor 401a determines that the operation for starting the use has been performed. In a case where it is determined that the operation for starting the use has been performed (YES in ACT162), the processing of the processor 401a proceeds to ACT163.

In ACT163, the processor 401a requests the mobile controller 3 to check in. Specifically, the processor 401a transmits request data for requesting check-in to the mobile controller 3 by wireless communication between the wireless communication device 401d and the access point 6. The request data is transmitted to the mobile controller 3 via the access point 6 and the store communication network 7. It should be noted that the processor 401a includes, in the request data for requesting check-in, the identification data for identifying the check-in request, the terminal code for identifying the cart terminal 400 including the processor 401a, and the membership code described above. It should be noted that when the start button is touched, the processor 401a notifies the virtual POS server 2 of a predetermined membership code for non-members. The membership code for non-members may be common to a plurality of customers or may be different. The notification data is transmitted to the mobile controller 3 via the access point 6 and the store communication network 7.

It should be noted that various requests from the cart terminal 400 to the mobile controller 3 to be described later are realized by transmitting request data including identification data for identifying the type of request from the user terminal 300 to the mobile controller 3 via the access point 6 and the store communication network 7 in the same manner as described above.

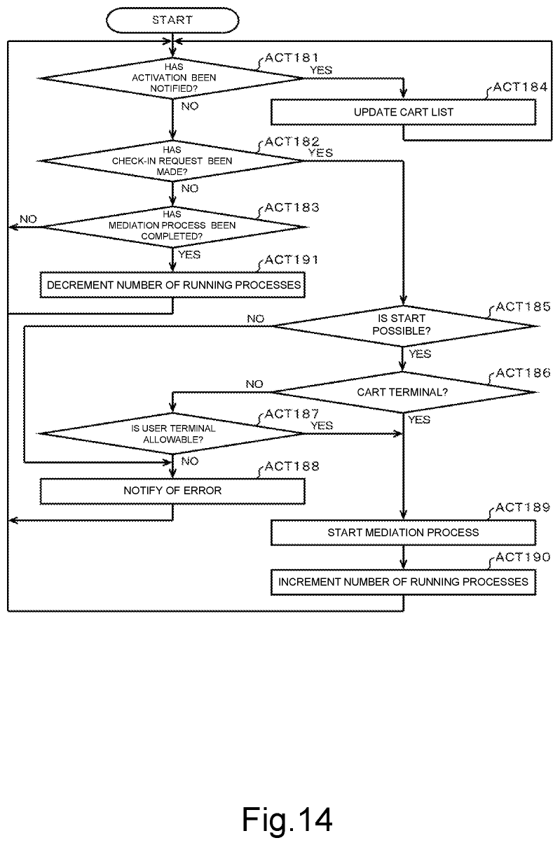

The processor 31 of the mobile controller 3 performs a management process in accordance with the transaction management application AP31. FIG. 14 is a flowchart showing the management process performed by the processor 31.

In ACT181 of FIG. 14, the processor 31 of the mobile controller 3 determines whether or not the activation notification (see ACT161 of FIG. 13) has been made from the cart terminal 400. Specifically, when the notification data for the activation notification transmitted from the cart terminal 400 has not been received by the communication interface 34, the processor 31 determines that the activation notification has not been made from the cart terminal 400 (NO in ACT181). Then, the processing of the processor 31 proceeds to ACT182. In ACT182, the processor 31 determines whether or not the request for starting the transaction (see ACT163 of FIG. 13) has been made from the user terminal 300 or the cart terminal 400. Hereinafter, it will be sometimes referred to as a transaction start request. Specifically, when the request data for the check-in request transmitted from the user terminal 300 or the cart terminal 400 has not been received by the communication interface 34, the processor 31 determines that the check-in request has not been made from the user terminal 300 or the cart terminal 400 (NO in ACT182). Then, the processing of the processor 31 proceeds to ACT183. In ACT183, the processor 31 determines whether or not the mediation process has been completed. In a case where it is determined that the mediation process has not been completed (NO in ACT183), the processing of the processor 31 returns to ACT181. As described above, the processor 31 waits for the end of the activation notification, the check-in request, or the mediation process in ACT181 to ACT183.

As described above, when the notification data for the activation notification transmitted from the cart terminal 400 is received by the communication interface 34, the processor 31 of the mobile controller 3 determines that the activation notification from the cart terminal 400 has been made (YES in ACT181). Then, the processing of the processor 31 proceeds to ACT184. In ACT184, the processor 31 updates a cart list. The cart list is data indicating a list of terminal codes of cart terminals 400 in operation. The cart list is stored in the main memory 32 or the auxiliary storage device 33. The processor 31 updates the cart list to add the terminal code included in the notification data (see ACT181) to the cart list, for example. The processor 31 may obtain various types of data related to the cart terminal 400, such as the SSID of the cart terminal 400, from the cart terminal 400, and may describe the data in the cart list in association with the terminal code. Thereafter, the processor 31 returns to the standby state of ACT181 to ACT183. It should be noted that although a specific description will be omitted, the processor 31 updates the cart list to eliminate the terminal code of the cart terminal 400 from the cart list when the operation stop of the cart terminal 400 is detected.

As described above, when the request data for the check-in request transmitted from the user terminal 300 or the cart terminal 400 is received by the communication interface 34, the processor 31 determines that the check-in request has been made (YES in ACT182). Then, the processing of the processor 31 proceeds to ACT185. In ACT185, the processor 31 determines whether or not the virtual POS server 2 can start new transaction process. As will be described later, the virtual POS server 2 performs a plurality of transaction processes concurrently. However, the number of transaction processes that the processor 21 can perform concurrently (hereinafter, referred to as maximum number) is limited due to resource limitations such as the processing capacity of the processor 21 of the virtual POS server 2. For example, in a case where the total number of transaction processes performed by the processor 21 of the virtual POS server 2 at that time is less than the maximum number, the processor 31 determines that the new transaction process can be started (YES in ACT185). Then, the processing of the processor 31 proceeds to ACT186.

In ACT186, the processor 31 determines whether or not it is the cart terminal 400 that has requested check-in. For example, the processor 31 determines whether or not the terminal code included in the request data is included in the cart list. In a case where the corresponding terminal code is not included in the cart list, the processor 31 determines that it is not the cart terminal 400 that has requested check-in (it is the user terminal 300) (NO in ACT186). Then, the processing of the processor 31 proceeds to ACT187. The processor 31 may determine whether it is the user terminal 300 or the cart terminal 400 that has requested check-in on the basis of a type data included in the request data. However, in this case, at least one of the processor 301 of the user terminal 300 or the processor 401a of the cart terminal 400 includes the type data for distinguishing the user terminal 300 from the cart terminal 400 in the request data for requesting check-in. In ACT187, the processor 31 compares the number of transaction processes (number of running processes) for the virtual POS servers 2, which are running in the virtual POS server 2, with a predetermined allowable number (allowable number of running processes by the virtual POS server 2). By this comparison, the processor 31 determines whether or not the start of the transaction process associated with the user terminal 300 is allowable in the virtual POS server 2. For example, in a case where the number of transaction processes (number of running processes) for the user terminals 300, which are running in the virtual POS server 2, is an allowable number, i.e., the number of running processes is equal to the allowable number, the processor 31 determines that the start of the transaction process associated with the user terminal 300 is not allowable in the virtual POS server 2 (NO in ACT187). Then, the processing of the processor 31 proceeds to ACT188. It should be noted that the processor 31 compares, for example, the number of running processes stored in the main memory 32 or the auxiliary storage device 33, as described later, with respect to the mediation process for the user terminal 300 with the allowable number for the determination here.

For example, for each store, the administrator of the store system 100 or the like determines the limit number of cart terminals 400 to be operated simultaneously in the store. The limit number is input through an input device such as the communication interface and the operating device 36 in accordance with an operation of the administrator or the like. The processor 31 stores the limit number in the main memory 32 or the auxiliary storage device 33 when the limit number is input in accordance with the operation of the administrator or the like. It should be noted that the processor 31 is overwritten with the newly input limit number in a case where the limit number is already stored in the main memory 32 or the auxiliary storage device 33. Then, the processor 31 sets a number obtained by subtracting the limit number from the maximum number as the allowable number. More specifically, in a case where the maximum number is 24 and the limit number is 15, the allowable number is 9. The mobile controller 3 in this example constantly guarantees that each of the limit number of cart terminals 400 can perform a transaction process as a target terminal concurrently. That is, the limit number corresponds to the guaranteed number of processes. The main memory 32 or the auxiliary storage device 33 that stores the limit number is an example of a storage means. The computer having the processor 31 of the mobile controller 3 as the central portion functions as an input means and an updating means.

It should be noted that the limit number may be determined by, for example, a creator of the transaction management application AP31 or the like, and may be fixedly applied to be common to all stores. Further, the allowable number may be determined by, for example, the creator of the transaction management application AP31 or the like, and may be fixedly applied to be common to all stores. Further, the allowable number may be a number obtained by subtracting the number of terminal codes described in the cart list, i.e., the number of cart terminals 400 in operation from the maximum number. Further, the allowable number may be a number obtained by subtracting, from the maximum number, an integer value obtained by multiplying the limit number or the number of cart terminals 400 in operation by a coefficient smaller than 1 or an integer value obtained by performing appropriate rounding on a number obtained by subtracting a certain number from the limit number or the number of cart terminals 400. Alternatively, in place of the limit number, the number of guaranteed connections, which is set independently of the limit number as a number less than the maximum number, may be stored in the main memory 32 or the auxiliary storage device 33, and a number obtained by subtracting the guaranteed connection number from the maximum number may be used as the allowable number.

Then, the processing of the processor 31 proceeds to ACT188 in the case of NO in ACT187 or in the case of NO in ACT185. It should be noted that as described above, the processor 31 of the mobile controller 3 determines that the new transaction process cannot be started in a case where the total number of transaction processes running in the processor 21 of the virtual POS server 2 is equal to the maximum number (NO in ACT185). The processor 31 determines the total number as the sum of the number of running processes stored in the main memory 32 and the number of running processes stored in the auxiliary storage device 33, for example, as will be described later. In ACT188, the processor 31 rejects the check-in request by notifying the user terminal 300 or the cart terminal 400 that is the check-in request source that the check-in is not permitted. Thereafter, the processor 31 returns to the standby state of ACT181 to ACT183. In other words, the processor 31 rejects the check-in request made from the user terminal 300 or the cart terminal 400 in a state in which the virtual POS server cannot start the new transaction process. Or, the processor 31 rejects the check-in request made from the user terminal 300 in a state in which the number of transaction processes for the user terminals 300 has reached the allowable number.

In a case where the virtual POS server 2 can start the new transaction process (YES in ACT185) and the check-in request is one from the cart terminal 400 (YES in ACT186), the processing of the processor 31 proceeds to ACT189. It should be noted that for example, in a case where the terminal code included in the request data for the check-in request is included in the cart list, the processor 31 determines that the check-in request is from the cart terminal 400 (YES in ACT186). Further, in a case where the virtual POS server 2 can start the new transaction process (YES in ACT185) and the check-in request is not from the user terminal 300 (NO in ACT186) but the number of running processes of the transaction processes associated with the user terminals 300 is less than the allowable number, it is determined that the start of the transaction process associated with the user terminal 300 is allowable (YES in ACT187), and the processing of the processor 31 proceeds to ACT189. In ACT189, the processor 31 starts the mediation process for the user terminal 300 or the cart terminal 400 that has requested check-in. It should be noted that the mediation process is performed by the processor 31 concurrently with the management process as a process in a thread separate from the management process, for example. It should be noted that when the processor 31 is performing a mediation process for another user terminal 300 or cart terminal 400, the processor 31 starts a new mediation process concurrently with that mediation process. That is, the processor 31 may perform a plurality of mediation processes concurrently.

In ACT190, the processor 31 increments the number of running processes of the mediation processes. For example, the processor 31 manages the number of running processes of the mediation processes for the user terminals 300 and the number of running processes of the mediation processes for the cart terminals 400 by storing them in the main memory 12 or the auxiliary storage device 13. When the processor 31 starts the mediation process for the user terminal 300 in ACT189, the processor 31 increments the number of running processes of the mediation processes for the user terminals 300 by 1. Further, when the processor 31 starts the mediation process for the cart terminal 400 in ACT189, the processor 31 increments the number of running processes of the mediation processes for the cart terminals 400 by 1. Thereafter, the processor 31 returns to the standby state of ACT181 to ACT183.

In a case where the processor 31 determines that the mediation process started in the above-mentioned manner is completed (YES in ACT183), the processing of the processor 31 proceeds to ACT191. In ACT191, the processor 31 decrements the number of running processes. For example, in a case where the terminated mediation process had targeted the user terminal 300, the processor 31 decrements the number of running processes of the mediation processes for the user terminals 300 by one. In a case where the terminated mediation process is for the cart terminal 400, the processor decrements the number of running processes of the mediation processes for the cart terminals 400 by one. Thereafter, the processor 31 returns to the standby state of ACT181 to ACT183.

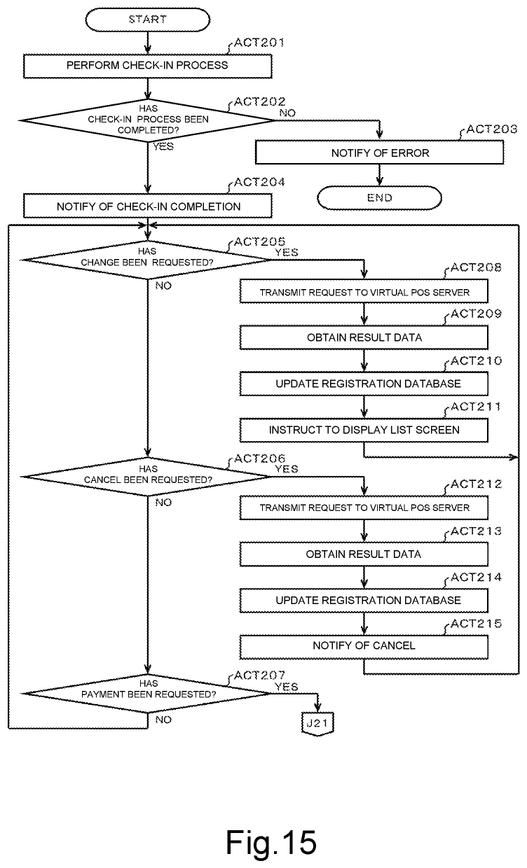

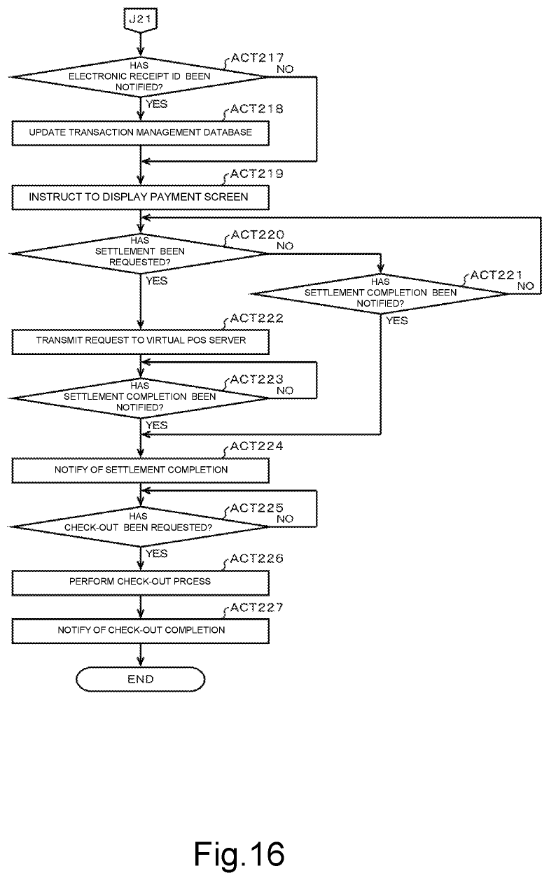

FIGS. 15 and 16 are flowcharts each showing the mediation process by the processor 31. As described above, the processor 31 may perform a plurality of mediation processes concurrently for the plurality of user terminals 300 or cart terminals 400. In the following description of the mediation process, as simply referred to as the user terminal 300 or the cart terminal 400, those refer to the user terminal 300 or the cart terminal 400 to be subjected to the mediation process. Further, when it is unnecessary to distinguish the user terminal 300 from the cart terminal 400 to be subjected to the mediation process, it will be referred to as a target terminal.

In ACT201 of FIG. 15, the processor 31 of the mobile controller 3 performs a check-in process. For example, the processor 31 requests the virtual POS server 2 to start a transaction and receives a notification of the transaction code. The processor 31 adds a new data record DR1 to the transaction management database DB31. The processor 31 sets the terminal code included in the request data in the field F11 of the new data record DR1. In a case where the request data includes a membership code, the processor 31 sets the membership code in the field F12 of the new data record DR1. The processor 31 sets the notified transaction code in the field F13 of the new data record DR1. In a case where the request data includes a point ID, the processor 31 attempts to obtain an electronic receipt ID associated with the point ID. That is, the processor 31 accesses, for example, the store server 1, checks the user database included in the database group DB11, and obtains the electronic receipt ID in a case where the electronic receipt ID is associated with the point ID. The processor 31 sets the electronic receipt ID in the field F14 of the new data record DR1 in a case where the electronic receipt ID can be obtained in this manner. Accordingly, the management of the transaction performed by using the target terminal is started.

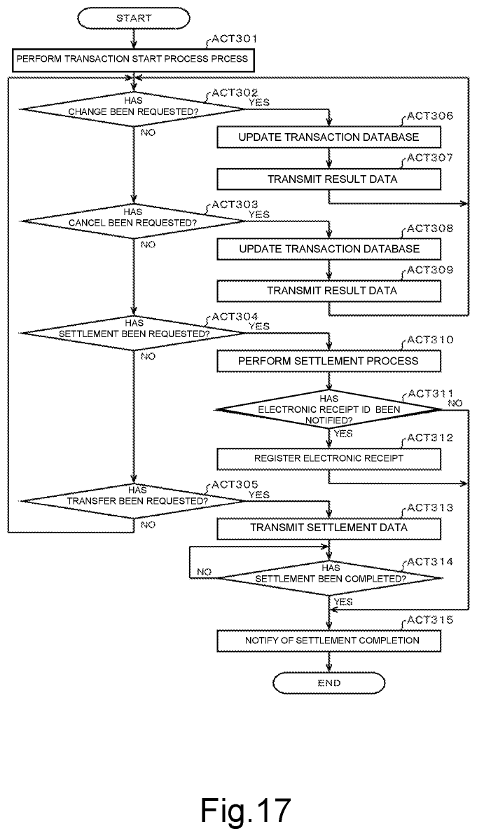

In the virtual POS server 2, the processor 21 starts the transaction process in accordance with the virtual POS application AP21 in a case where the transaction start is requested from the mobile controller 3. FIG. 17 is a flowchart showing the transaction process by the processor 21.

Every time the start of a transaction is requested, the processor 21 starts the transaction process. When another transaction process is running in the processor 21, the processor 21 starts the new transaction process concurrently. That is, when a plurality of mediation processes are concurrently performed in the mobile controller 3, the processor 21 performs a plurality of transaction processes respectively corresponding to the plurality of mediation processes concurrently.

That is, the processor 31 of the mobile controller 3 starts the mediation process in response to the request from the user terminal 300 or the cart terminal 400 as the terminal device, to thereby cause the processor 21 of the virtual POS server 2 to start the transaction process according to the instruction from the terminal device that is the request source. However, in a case where the terminal device that is the request source is the user terminal 300 as the terminal device belonging to the first type and the predetermined allowable number of transaction processes are running in the processor 21 using the user terminals 300 as the target terminals, the processor 31 does not cause it to start the transaction process in response to the request (request from the user terminal 300). By the processor 31 performing the information processing based on the transaction management application AP31 as described above, the computer having the processor 31 as the central portion functions as a control means.

In ACT301 of FIG. 17, the processor 21 of the virtual POS server 2 performs a transaction start process. In the transaction start process, the processor 21 determines a transaction code according to a predetermined rule and updates the transaction database DB21 to include a new data record for managing purchased commodities in the transaction identified by the transaction code. The processor 21 notifies the mobile controller 3 of the determined transaction code.

In ACT302, the processor 21 of the virtual POS server 2 determines whether or not a change of some of the purchased commodities has been requested. In a case where it is determined that the change of some of the purchased commodities has not been requested (NO in ACT302), the processing of the processor 21 proceeds to ACT303. In ACT303, the processor 21 determines whether or not cancel of the transaction has been requested. In a case where it is determined that the cancel of the transaction has not been requested (NO in ACT303), the processing of the processor 21 proceeds to ACT304. In ACT304, the processor 21 determines whether or not settlement has been requested. In a case where it is determined that the settlement has not been requested (NO in ACT304), the processing of the processor 21 proceeds to ACT305. In ACT305, the processor 21 determines whether or not transfer of settlement data has been requested. In a case where it is determined that the transfer of the settlement data has not been requested (NO in ACT305), the processing of the processor 21 returns to ACT302. As described above, the processor 21 waits for either the change, the cancel, the settlement or the transfer to be requested at ACT302 to ACT305.

The processing of the processor 31 of the mobile controller 3 proceeds to ACT202 of FIG. 15 after the check-in process in ACT201 of FIG. 15 is completed. In ACT202, the processor 31 determines whether or not the check-in process has been normally completed. In a case where it is determined that the check-in process has not been normally completed due to some error (NO in ACT202), the processing of the processor 31 proceeds to ACT203. In ACT203, the processor 31 notifies the target terminal of the error. The processor 31 transmits, for example, notification data for error notification to the target terminal via the store communication network 7 and the access point 6. The processor 31 includes identification data in the notification data for identifying the error notification. The processor 31 may include an error code for indicating the cause of the error in the notification data. Then, the processor 31 terminates the mediation process.

It should be noted that various notifications from the mobile controller 3 to the target terminal such below are realized by transmitting notification data including identification data for identifying the type of notification from the mobile controller 3 to the target terminal via the store communication network 7 and the access point 6 as in the above.

On the other hand, in a case where it is determined that the check-in process has completed successfully (YES in ACT202), the processing of the processor 31 proceeds to ACT204. In ACT204, the processor 31 notifies the target terminal of the check-in completion.

In ACT108 of FIG. 9, the processor 301 of the user terminal 300 determines whether or not check-in completion has been notified in ACT109 after requesting check-in. In a case where it is determined that the check-in completion has not been notified (NO in ACT109), the processing of the processor 301 proceeds to ACT110. In ACT110, the processor 301 determines whether or not a check-in error has been notified. In a case where it is determined that the check-in error has not been notified (NO in ACT110), the processing of the processor 301 returns to ACT109. As described above, the processor 301 waits for check-in completion or notification of a check-in error in ACT109 and ACT110. In a case where notification data for check-in error notification is received by the wireless communication device 306, the processor 301 determines that a check-in error has been notified (YES in ACT110). Then, the processing of the processor 301 proceeds to ACT111.

In ACT111, the processor 301 causes the touch panel 304 to display an error screen. The error screen is a screen for notifying the customer that the check-in is impossible. It should be noted that for example, for the error notification in ACT188 of FIG. 14 described above, the processor 31 causes the touch panel 304 to display an error screen notifying that the check-in is impossible because the store is congested and prompting the user to re-try the check-in after a while. The display of the error screen is an example of a notification operation to indicate that it is unavailable. That is, the error notification performed by the processor 31 of the mobile controller 3 in ACT188 of FIG. 14 corresponds to instructing the user terminal 300 as the terminal device to perform the notification operation. By the processor 31 performing the information processing based on the transaction management application AP31 as described above, the computer having the processor 31 as the central portion functions as an instruction means. It should be noted that when an instruction to cancel the display of the error screen is made by operating the GUI element or the like displayed on the error screen, for example, the processing of the processor 301 returns to ACT101.

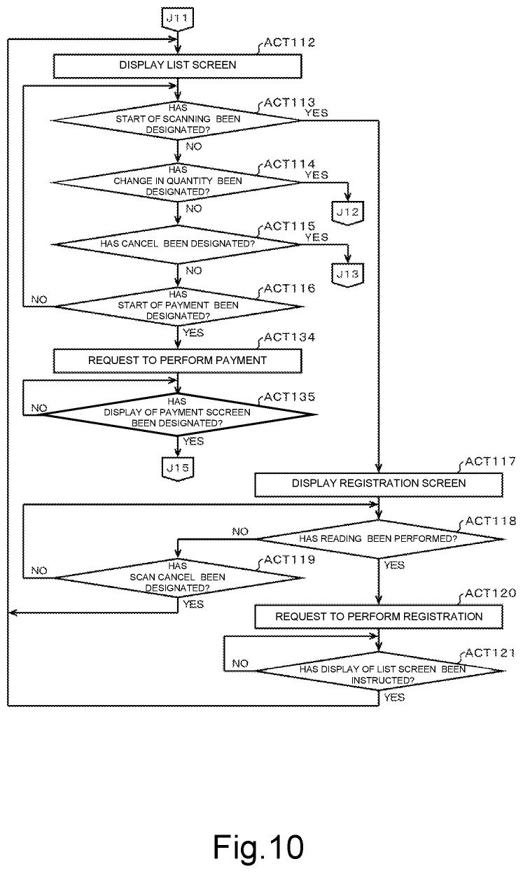

On the other hand, the processor 301 determines that the check-in completion has been notified (YES in ACT109) when the notification data for notification of the above-mentioned check-in completion has been received by the wireless communication device 306. Then, the processing of the processor 301 proceeds to ACT112 of FIG. 10. In ACT112, the processor 301 of the user terminal 300 causes the touch panel 304 to display a list screen. The list screen is a screen for displaying a list of registered purchased commodities.

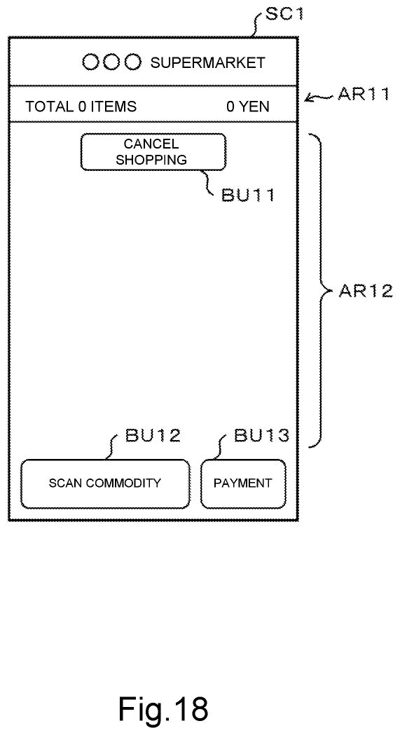

FIG. 18 is a diagram showing an example of a list screen SC1. The list screen SC1 includes display areas AR11 and AR12 and buttons Bull, BU12, and BU13. The display area AR11 displays the total number of purchased commodities and the total amount of money for the purchased commodities. The display area AR12 displays a list of purchased commodities. The button BU11 is a soft key for the customer to declare that the customer cancels all the purchased commodities and also cancels the shopping. The button BU12 is a soft key for the customer to declare that the customer starts scanning the commodities to be registered as the purchased commodities. The button BU13 is a soft key for the customer to declare BU13 that the customer starts payment. It should be noted that FIG. 18 shows list screen SC1 in a state in which the purchased commodities have not yet been registered. Therefore, “0” is displayed as both the total number and the total amount of money on the display area AR11 and nothing is displayed on the display area AR12.

In ACT113 of FIG. 10, the processor 301 of the user terminal 300 determines whether or not the start of scanning the commodities has been designated. In a case where it is determined that the start of scanning the commodities has not been designated (NO in ACT113), the processing of the processor 301 proceeds to ACT114. In ACT114, the processor 301 of the user terminal 300 determines whether or not a change in quantity has been designated. In a case where it is determined that the change in quantity has not been designated (NO in ACT114), the processing of the processor 301 proceeds to ACT115. In ACT115, the processor 301 determines whether or not cancel of the shopping has been designated. In a case where it is determined that the cancel of the shopping has not been designated (NO in ACT115), the processing of the processor 301 proceeds to ACT116. In ACT116, the processor 301 determines whether or not the start of the payment has been designated. In a case where it is determined that the start of the payment has not been designated (NO in ACT116), the processing of the processor 301 returns to ACT113. As described above, the processor 301 waits for either the scan start, the change in quantity, the cancel, or the payment start to be designated in ACT113 to ACT116.

When registering the commodities as the purchased commodities, the customer designates the start of scanning by a predetermined operation such as touching the button BU12 on the list screen SC1 of FIG. 18. In response to it, the processor 301 of the user terminal 300 determines that the start of scanning the commodities has been designated (YES in ACT113). Then, the processing of the processor 301 proceeds to ACT117. In ACT117, the processor 301 causes the touch panel 304 to display a registration screen. The registration screen is a screen for prompting the customer to read barcodes representing the commodity codes of commodities to be registered as purchased commodities.

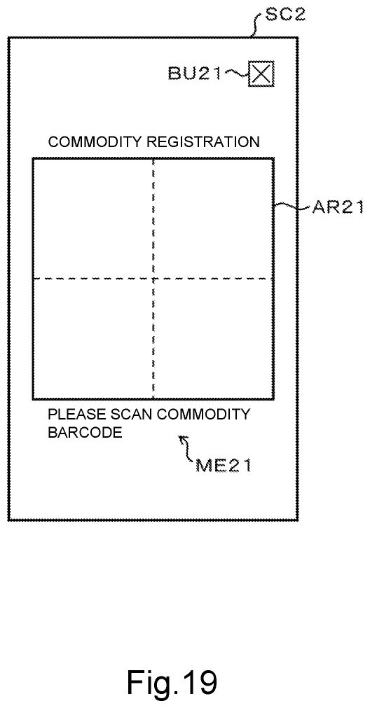

FIG. 19 is a diagram showing an exemplary registration screen SC2. The registration screen SC2 includes a display area AR21, a message ME21, and a button BU21. The display area AR21 displays an image obtained by the camera 305. The message ME21 is a character message that prompts the customer to read the barcodes of the commodities. The button BU21 is a soft key for the customer to declare that the customer cancels the scanning of the commodity codes. For example, the processor 301 activates the camera 305 and generates the registration screen SC2 by superimposing an image showing a line indicating the range of the display area AR21 and the message ME21 and the button BU21 on the image thus obtained by the camera 305.

In ACT118 of FIG. 10, the processor 301 of the user terminal 300 determines whether or not the barcode has been read. At this time, the processor 301 analyzes the image obtained by the camera 305 and attempts to read the barcode. The barcode reading may be read as a process based on the smartphone POS application AP301 or as a process based on another application program for reading the barcode. In a case where it is determined that the barcode cannot be read (NO in ACT118), the processing of the processor 301 proceeds to ACT119. In ACT119, the processor 301 determines whether or not scan cancel has been designated. In a case where it is determined that the scan cancel has not been designated (NO in ACT119), the processing of the processor 301 returns to ACT118. The processor 301 waits for the barcode to be read or the scan cancel to be designated in ACT118 and ACT119 as described above.

When the customer wishes to return to the list screen without performing the current scan, the customer designates the scan cancel by a predetermined operation such as touching the button BU21. In response to it, the processor 301 determines that the scan cancel has been designated (YES in ACT119). Then, the processing of the processor 301 returns to ACT112.

When the registration screen is displayed on the touch panel 304, the customer directs the camera 305 to the commodity such that the barcode displayed on the commodity to be registered as the purchased commodity is reflected on the display area AR21. In response to it, the processor 301 of the user terminal 300 determines that the barcode has been read (YES in ACT118). Then, the processing of the processor 301 proceeds to ACT120. In ACT120, the processor 301 requests the mobile controller 3 of the registration. The processor 301 includes data (hereinafter, referred to as barcode data) indicated by the read barcode in the request data transmitted here. In ACT121, the processor 301 waits for the display of the list screen to be instructed while determining whether or not the display of the list screen has been instructed.

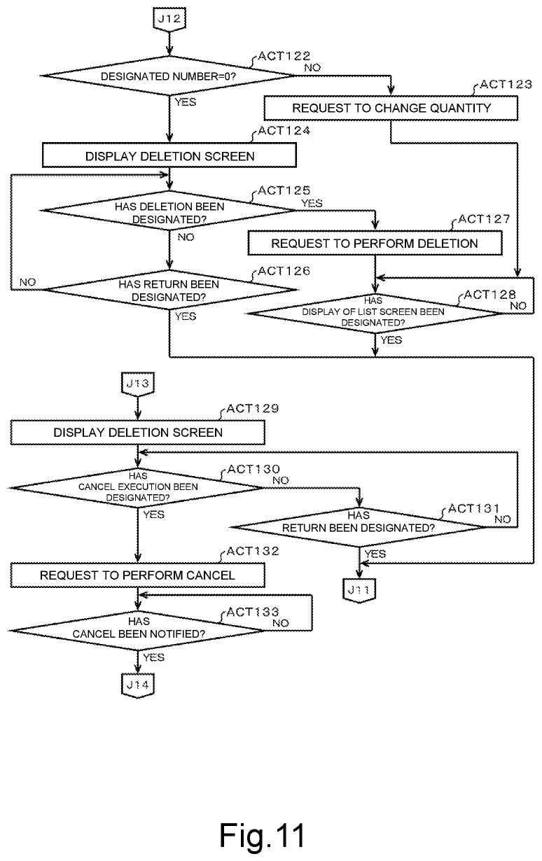

When the customer touches the area displaying the number of commodities on the list screen SC1 under the standby state in ACT113 to ACT116, the processor 301 causes the list screen SC1 to display a list box for designating the number of commodities. When the list box is operated by the customer, the processor 301 receives it as quantity designation. In this case, the processor 301 determines that the change in quantity has been designated (YES in ACT114 of FIG. 10). Then, the processing of the processor 301 proceeds to ACT122 of FIG. 11.

In ACT122 of FIG. 11, the processor 301 of the user terminal 300 determines whether or not the designated number is 0. In a case where it is determined that the designated number is not 0 (NO in ACT122), the processing of the processor 301 proceeds to ACT123. In ACT123, the processor 301 requests the mobile controller 3 to change the quantity. The processor 301 includes identification data for identifying the commodity the quantity of which has been designated and the designated number in the request data transmitted here. The identification data may be a commodity code or may be data based on which the purchased commodity can be identified only by the mobile controller 3, such as a number for identifying each purchased commodity in the list of purchased commodities. It should be noted that in a case where the commodity code is used as the identification data, the processor 31 of the mobile controller 3 includes the commodity code for each purchased commodity in instruction data for instructing to display the list screen.

In a case where it is determined that the designated number is 0 (YES in ACT122), the processing of the processor 301 proceeds to ACT124. In ACT124, the processor 301 causes the touch panel 304 to display a deletion screen. The deletion screen is a screen for notifying the customer that the commodity the quantity of which has been designated to be 0 is deleted from the purchased commodity. The delete screen includes a delete button to for designating deletion and a return button for designating return to the state before designating the change in quantity without changing the quantity.

In ACT125, the processor 301 determines whether or not deletion has been designated. In a case where it is determined that the deletion has not been designated (NO in ACT125), the processing of the processor 301 proceeds to ACT126. In ACT126, the processor 301 determines whether or not return has been designated. In a case where it is determined that the return has not been designated (NO in ACT126), the processing of the processor 301 returns to ACT125. As described above, the processor 301 waits for the deletion or return to be designated in ACT125 and ACT126.

In a case where the customer wishes to cancel the deletion and return to the state before designating the change in quantity, the customer designates the return by a predetermined operation such as touching the return button on the deletion screen. In response to it, the processor 301 determines that the return has been designated (YES in ACT126). Then, the processing of the processor 301 returns to ACT112 of FIG. 10. In this case, since the registration state of the purchased commodity is not changed, the processor 301 causes the touch panel 304 to display again the list screen SC1 in the same state as that displayed before displaying the deletion screen.

In a case where the customer truly wishes to perform deletion, the customer designates the deletion by a predetermined operation such as touching the deletion button on the deletion screen. In response to it, the processor 301 determines that the deletion has been designated (YES in ACT125). Then, the processing of the processor 301 proceeds to ACT127. In ACT127, the processor 301 of the user terminal 300 requests the mobile controller 3 of the deletion. The processor 301 includes identification data for identifying the commodity for which the deletion has been designated in the request data transmitted here.

The processor 301 of the user terminal 300 waits for the display of the list screen to be instructed while determining whether or not the display of the list screen has been instructed in ACT128 after requesting to change in quantity in ACT123 or requesting to perform deletion in ACT127.

After notifying of the check-in completion in ACT204 of FIG. 15, the processor 31 of the mobile controller 3 determines whether or not a change of the purchased commodity has been requested in ACT205. In a case where it is determined that the change of the purchased commodity has not been requested (NO in ACT205), the processing of the processor 31 proceeds to ACT206. In ACT206, the processor 31 determines whether or not cancel of the purchased commodity has been requested. In a case where the processor 31 determines that the cancel of the purchased commodity has not been requested (NO in ACT206), the processing of the processor 31 proceeds to ACT207. In ACT207, the processor 31 determines whether or not payment has been requested. In a case where it is determined that the payment has not been requested (NO in ACT207), the processing of the processor 31 returns to ACT205. As described above, the processor 31 waits for either the change, the cancel, or the payment to be requested in ACT205 to ACT207. When the change has been requested from the user terminal 300 as the target terminal as described above, the processor 31 determines that the change of the purchased commodity has been requested (YES in ACT205). Then, the processing of the processor 31 proceeds to ACT208.

In ACT208, the processor 31 transmits the request from the user terminal 300 to the virtual POS server 2 with a notification of the transaction code of the transaction to be processed. At this time, the processor 31 may transfer the request data transmitted from the user terminal 300 as it is to the virtual POS server 2 or may transmit the request data converted by a certain process to the virtual POS server 2. However, the processor 31 notifies the virtual POS server 2 of the barcode data or the identification data included in the request data transmitted from the user terminal 300.

When the request data related to the registration, the change in quantity, or the deletion is transferred from the mobile controller 3 under the standby state of ACT302 to ACT305 of FIG. 17, the processor 21 of the virtual POS server 2 determines that the change of the purchased commodity has been requested (YES in ACT302). Then, the processing of the processor 21 proceeds to ACT306. In ACT306, the processor 21 updates the transaction database DB21 in response to the request in the transferred request data. For example, in a case where the registration has been requested, the processor 21 determines that the barcode data included in the request data has been read by a barcode scanner provided in the existing POS terminal and attempts to register the purchased commodity by a process similar to that of the existing POS terminal. However, the commodity code indicated by the barcode data may not be registered in the commodity database due to a certain cause. Or, a barcode different from the barcode indicating the commodity code may be attached to the commodity. In such a case, the processor 21 of the virtual POS server 2 cannot register the purchased commodity and considers it as an error. In this manner, the processor 21 registers the purchased commodity on the basis of normal barcode reading. For example, in a case where the change in quantity has been requested, the processor 21 changes the quantity indicated in the transaction database DB21 with respect to the commodity the quantity of which to be changed. For example, in a case where the deletion has been requested, the processor 21 updates the transaction database DB21 to remove the commodity to be deleted from the purchased commodity.

In ACT307, the processor 21 transmits result data indicating the result of the above-described process to the mobile controller 3. When the registration of the purchased commodity is correctly performed, the processor 21 includes identification data for identifying the normal registration notification, and the commodity code, the commodity name, and the price of the registered commodity in the result data. In a case where the quantity is changed, the processor 21 includes the commodity code of the changed commodity and the quantity after the change in the result data. In a case where the purchased commodity has been deleted, the processor 21 includes the commodity code of the commodity removed from the purchased commodity in the result data. In a case of considering that the error has occurred, the processor 21 includes the identification data for identifying the error notification and the barcode data transmitted in the registration request in the result data. After transmitting the result data, the processor 21 returns to the standby state in ACT302 to ACT305.

The processor 31 of the mobile controller 3 transfers the request in ACT208 of FIG. 15, and then obtains the result data transmitted from the virtual POS server 2 in the above-mentioned manner. The processor 31 stores the obtained result data in the main memory 32 or the auxiliary storage device 33.

In ACT210, the processor 31 updates the registration database DB32 on the basis of the result data. The registration database DB32 is updated as follows, for example. First case: a case where the result data is the normal registration notification and the registration data including the notified commodity code is not included in the data record DR2 associated with the transaction to be processed. In this case, the processor 31 adds a new field subsequent to the last field that already exists in the data record DR2 associated with the transaction to be processed and adds new registration data to that field. The processor 31 includes, in the new registration data, the notified commodity code, an error flag of “0” indicating that it is not an error, the notified commodity name and price, the quantity “1”, and a cancel flag of “0” indicating that it has not been canceled. The registration data thus added in this case has a structure as shown on the upper right side of FIG. 6.

Second case: a case where the result data is the normal registration notification and the registration data including the notified commodity code is included in the data record DR2 associated with the transaction to be processed but the cancel flag of the registration data is “1” indicating that the cancel flag of the registration data has been canceled. In this case, the processor 31 performs the same process as in the first case described above.

Third case: a case where the result data is the normal registration notification, the registration data including the notified commodity code is included in the data record DR2 associated with the transaction to be processed, and the cancel flag of the registration data is “0”. In this case, the processor 31 rewrites the value of the quantity included in the registration data including the notified commodity code and having the cancel flag set to “0” to a value that is one more than that value.

Fourth case: a case where the result data is the notification of the change in quantity. In this case, the processor 31 finds the registration data including the notified commodity code from the data record DR2 associated with the transaction to be processed. Then, the processor 31 rewrites the quantity included in the corresponding registration data to the quantity included in the result data.

Fifth case: a case where the result data is the deletion notification. In this case, the processor 31 finds the registration data including the notified commodity code from the data record DR2 associated with the transaction to be processed. The processor 31 changes the cancel flag included in the corresponding registration data to “1”.

Sixth case: a case where the result data is the error notification. In this case, the processor 31 adds a new field subsequent to the last field that already exists in the data record DR2 associated with the transaction to be processed and adds new registration data to that field. The processor 31 includes, in the new registration data, the notified barcode data and an error flag of “1” indicating an error. The registration data thus added in this case has a structure as shown on the lower right side of FIG. 6.

By being updated by the processor 31 in this manner, the registration database DB32 becomes one indicating a list of purchased commodities registered in the virtual POS server 2 and recording barcode reading resulting in an error in addition to the list. It should be noted that the processor 31 stores the barcode data transmitted in the registration request in the main memory 32 or the auxiliary storage device 33. The processor 31 may include the stored barcode data in the registration data in the sixth case described above. In this case, the processor 21 of the virtual POS server 2 does not need to include the barcode data in the result data. Alternatively, the processor 31 may extract the commodity code from the stored barcode data and perform the process shown in the first to fifth cases on the basis of that commodity code. Additionally, the processor 31 may obtains from the store server 1 or the like on the basis of the commodity code.

In ACT211, the processor 31 instructs the user terminal 300 to display a list screen. The processor 31 transmits, for example, instruction data including identification data for identifying the instruction of the display of the list screen to the user terminal 300 via the store communication network 7 and the access point 6. The processor 31 includes, in the instruction data, the commodity code, the commodity name, the price, and the quantity included in the data record DR2 associated with the transaction to be processed in the registration database DB32. Further, in a case where the current registration is determined as an error, the processor includes error data indicating this fact in the instruction data. Thereafter, the processor 31 returns to the standby state of ACT205 to ACT207.

It should be noted that various instructions from the mobile controller 3 to the user terminal 300 to be described later are realized by transmitting instruction data including identification data for identifying the type of instruction from the mobile controller 3 to the user terminal 300 via the store communication network 7 and the access point 6 as in the above.

When the wireless communication device 306 of the user terminal 300 receives the result data in any of the first to third cases and the sixth case described above, the processor 301 of the user terminal 300 determines that the display of the list screen has been instructed (YES in ACT121 of FIG. 10). Further, when the wireless communication device 306 receives the result data in the fourth or fifth case, the processor 301 determines that the display of the list screen has been instructed (YES in ACT128 of FIG. 11). In those cases, the processing of the processor 301 returns to ACT112 of FIG. 10. In ACT112, the processor 301 causes the touch panel 304 to display the list screen SC1 again. At this time, the processor 301 sets the list screen SC1 to a screen displaying the commodity name, price, and quantity of the purchased commodity included in the instruction data. Further, in a case where the instruction data includes error data, the processor 301 adds the fact that the commodity has not been correctly registered to the list screen SC1 for displaying it.

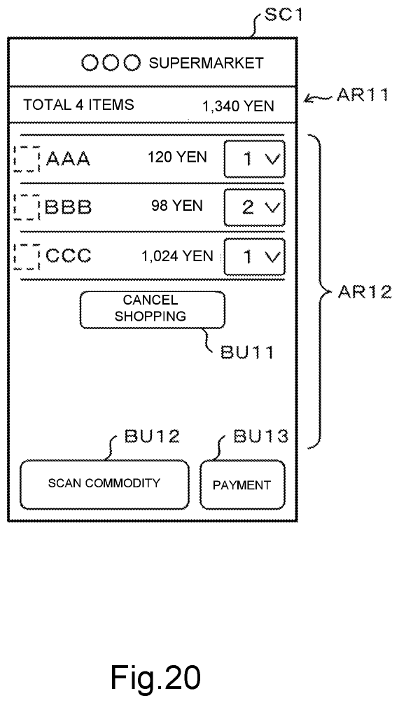

FIG. 20 is a diagram showing an exemplary list screen SC1 in a state in which the purchased commodities have already been registered. The list screen SC1 shown in FIG. 20 is an example in a case where one commodity whose commodity name is “AAA” and whose price is 120 yen, two commodities whose commodity name is “BBB” and whose price is 98 yen for each, and one commodity whose commodity name is “CCC” and whose price is 1,024 yen have been registered as the purchased commodities. The list screen SC1 shown in FIG. 20 displays the names, prices, and quantity of those registered commodities in the display area AR12. Further, “4” is displayed as the total number and “1,340” is displayed as the total amount of money in the display area AR11. It should be noted that the area surrounded by the dashed line on the left-hand side of the commodity name is an area for displaying an icon. The dashed line representing that area is not actually displayed on the list screen SC1.

When the customer wishes to cancel all the purchased commodities that have already been registered and also cancel the shopping, the customer designates the cancel by a predetermined operation such as touching the button BU11 on the list screen SC1. In response to it, the processor 301 of the user terminal 300 determines that the cancel of the shopping has been designated (YES in ACT115 of FIG. 10). Then, the processing of the processor 301 proceeds to ACT129 of FIG. 11. In ACT129, the processor 301 causes the touch panel 304 to display a cancel screen. The cancel screen is a screen for notifying the customer that all the purchased commodities that have already been registered are canceled. The cancel screen includes an execution button for designating cancel execution and a return button for designating return to the state before designating the cancel of the shopping without designating the cancel execution.

In ACT130 of FIG. 11, the processor 301 determines whether or not the cancel execution has been designated. In a case where it is determined that the cancel execution has not been designated (NO in ACT130), the processing of the processor 301 proceeds to ACT131. In ACT131, the processor 301 determines whether or not the return has been designated. In a case where it is determined that the return has not been designated (NO in ACT131), processing of the processor 301 returns to ACT130. As described above, the processor 301 waits for the cancel execution or the return to be designated in ACT130 and ACT131.

For continuing the shopping, the customer designates the return by a predetermined operation such as touching the return button on the cancel screen. In response to it, the processor 301 determines that the return has been designated (YES in ACT131). Then, the processing of the processor 301 returns to ACT112 of FIG. 10. In ACT112, the processor 301 causes the touch panel 304 to display the list screen SC1 again. In this case, since the registration state of the purchased commodity is not changed, the processor 301 causes the touch panel 304 to display again the list screen SC1 in the same state as that displayed before displaying the cancel screen.

For cancelling the shopping, the customer designates the cancel execution by a predetermined operation such as touching the execution button on the cancel screen. In response to it, the processor 301 determines that the cancel execution has been designated (YES in ACT130). Then, the processing of the processor 301 proceeds to ACT132. In ACT132, the processor 301 of the user terminal 300 requests the mobile controller 3 to perform cancel.

In a case where the cancel is requested from the user terminal 300 as described above, the processor 31 of the mobile controller 3 determines that the cancel of the purchased commodities has been requested (YES in ACT206 of FIG. 15). Then, the processing of the processor 31 proceeds to ACT212. In ACT212, the processor 31 transmits the cancel request to the virtual POS server 2 with a notification of the transaction code of the transaction to be processed. At this time, the processor 31 may transfer the request data transmitted from the user terminal 300 as it is to the virtual POS server 2 or may transmit the request data converted by a certain process to the virtual POS server 2.

When the request data related to the cancel is transferred from the mobile controller 3 under the standby state of ACT302 to ACT305 of FIG. 17, the processor 21 of the virtual POS server 2 determines that the cancel of the transaction has been requested (YES in ACT303 of FIG. 17). Then, the processing of the processor 21 proceeds to ACT308. In ACT308, the processor 21 updates the transaction database DB21 in response to the request in the transferred request data. For example, the processor 21 determines that the request based on the request data transmitted from the mobile controller 3 is a cancel instruction input through an input device provided in the existing POS terminal. The processor 21 updates the transaction database DB21 to remove all the commodities that have been registered in association with the notified transaction code from the purchased commodities by a process similar to that of the existing POS terminal.

In ACT309 of FIG. 17, the processor 21 of the virtual POS server 2 transmits the result data indicating the result of the above-described process to the mobile controller 3. The processor 21 includes the commodity codes of all the commodities removed from the purchased commodities in the result data. After transmitting the result data, the processor 21 returns to the standby state in ACT302 to ACT305.

After the processor 31 of the mobile controller 3 transfers the cancel request in ACT212 of FIG. 15, the processing of the processor 31 proceeds to ACT213. In ACT213, the processor 31 obtains the result data transmitted from the virtual POS server in the above-mentioned manner. The processor 31 stores the obtained result data in the main memory 32 or the auxiliary storage device 33.

In ACT214, the processor 31 of the mobile controller 3 updates the registration database DB32 on the basis of the result data described above. That is, the processor 31 changes the cancel flag set to “0” to “1” for all the registered data included in the data record DR2 associated with the transaction to be processed. In ACT215, the processor 31 notifies the user terminal 300 of the cancel. Thereafter, the processing of the processor 31 returns to the standby state of ACT205 to ACT207.

After the processor 301 of the user terminal 300 requests to perform cancel in ACT132 of FIG. 11, the processing of the processor 301 proceeds to ACT133. In ACT133, the processor 301 waits for the cancel to be notified by the mobile controller 3. In a case where it is determined that the cancel has been notified as described above (YES in ACT133), the processing of the processor 301 returns to ACT101 of FIG. 9.

After the customer registers all the commodities, which the customer wishes to purchase, as the purchased commodities, the customer proceeds to settlement. At this time, the customer designates the payment start by a predetermined operation such as touching the button BU13 on the list screen SC1 of FIG. 20, for example. In response to it, the processor 301 of the user terminal 300 determines that the payment start has been designated (YES in ACT116 of FIG. 10). Then, the processing of the processor 301 proceeds to ACT134. In ACT134, the processor 301 requests the mobile controller 3 to perform payment. The processor 301 of the user terminal 300 includes the terminal code in the request data transmitted here. The processor 301 also includes the electronic receipt ID in the request data in a case where the electronic receipt ID is stored in the auxiliary storage device 303. In ACT135, the processor 301 waits for the display of the payment screen to be designated.

In a case where the processor 31 of the mobile controller 3 determines that payment has been requested from the user terminal 300 as described above (YES in ACT207 of FIG. 15), the processing of the processor 31 of the mobile controller 3 proceeds to ACT217 of FIG. 16. In ACT217, the processor 31 determines whether or not the electronic receipt ID has been notified by the user terminal 300. In a case where the electronic receipt ID is included in the request data from the user terminal 300, the processor 31 determines that the electronic receipt ID has been notified by the user terminal 300 (YES in ACT217). Then, the processing of the processor 31 proceeds to ACT218.

In ACT218, the processor 31 of the mobile controller 3 updates the transaction management database DB31 of FIG. 4 to record the electronic receipt ID notified by the user terminal 300. For example, the processor 31 searches the transaction management database DB31 for the data record DR1 (see FIG. 5) having the field F11 in which the terminal code included in the request data from the user terminal 300 has been set. The processor 31 sets the electronic receipt ID included in the request data in the field F14 of the corresponding data record DR1. It should be noted that in a case where the electronic receipt ID has already been set in the field F14 of the corresponding data record DR1, the processor 31 overwrites it with the electronic receipt ID included in the request data.

After the processor 31 of the mobile controller 3 updates the transaction management database DB31, the processing of the processor 31 proceeds to ACT219. It should be noted that in a case where the electronic receipt ID is not included in the request data, the processor 31 determines that the electronic receipt ID has not been notified by the user terminal 300 (NO in ACT217). Then, the processing of the processor 31 skips ACT218 and proceeds to ACT219. In ACT219, the processor 31 instructs the user terminal 300 to display the payment screen.

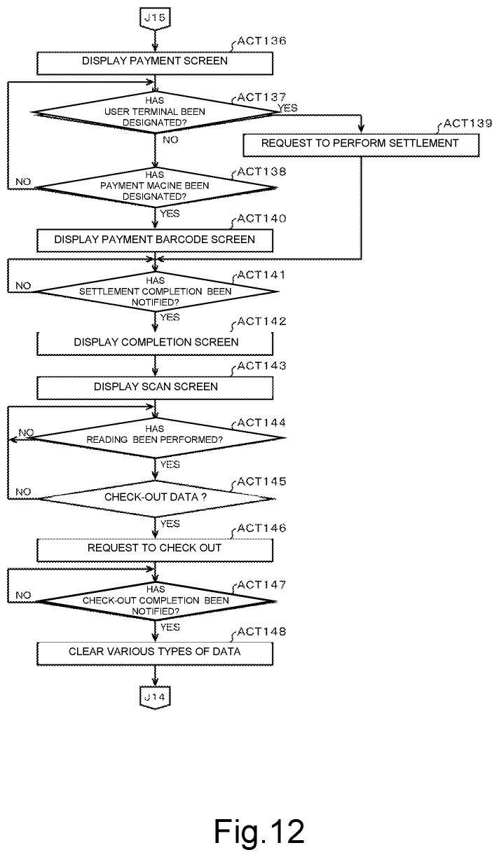

In a case where the processor 301 of the user terminal 300 is instructed to display the payment screen as described above (YES in ACT135 of FIG. 10), the processing of the processor 301 proceeds to ACT136 of FIG. 12. In ACT136, the processor 301 causes the touch panel 304 to display a payment screen. The payment screen is a screen for the customer to select which of the user terminal 300 and the payment machine 5 is to be used for performing an operation for settlement.

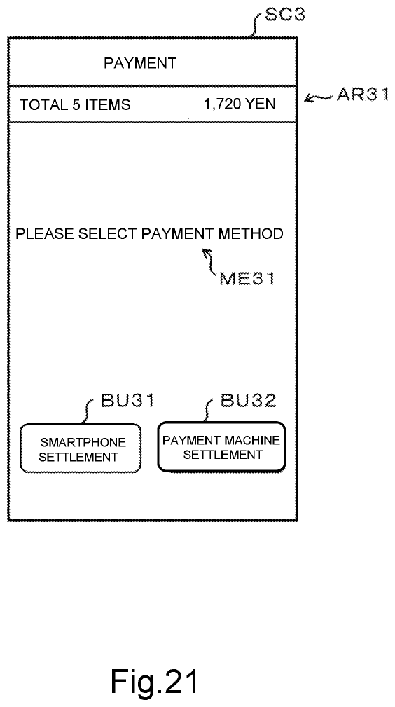

FIG. 21 is a diagram showing an exemplary payment screen SC3. The payment screen SC3 includes a display area AR31, a message ME31, and buttons BU31 and BU32. The display area AR31 displays the total number of purchased commodities and the total amount of money for the purchased commodities. The message ME31 is a character message that prompts the customer to designate which of the user terminal 300 and the payment machine 5 is used for performing the operation for settlement. The button BU31 is a soft key for the customer to designate the user terminal 300. The button BU32 is a soft key for the customer to designate the payment machine 5.

In ACT137 of FIG. 12, the processor 301 of the user terminal 300 determines whether or not the user terminal 300 has been designated. In a case where it is determined that the user terminal 300 has not been designated (NO in ACT137), processing of the processor 301 proceeds to ACT138. In ACT138, the processor 301 determines whether or not the payment machine 5 has been designated. In a case where the processor 301 determines that the payment machine 5 has not been designated (NO in ACT138), the processing of the processor 301 returns to ACT137. As described above, the processor 301 waits for the user terminal 300 or the payment machine 5 to be designated in ACT137 and ACT138.

When the customer wishes to perform the operation for settlement by using the user terminal 300, the customer designates the user terminal 300 by a predetermined operation such as touching the button BU31. In response to it, the processor 301 of the user terminal 300 determines that the user terminal 300 has been designated (YES in ACT137). Then, the processing of the processor proceeds to ACT139. In ACT139, the processor 301 requests the mobile controller 3 to perform settlement. It should be noted that the processor 301 may include settlement information such as a credit number and a user code for an online settlement service, which are required for settlement, in the request data for requesting to perform settlement.

After the processor 31 of the mobile controller 3 instructs the display of the payment screen in ACT219 of FIG. 16, the processing of the processor 31 proceeds to ACT220. In ACT220, the processor 31 determines whether or not settlement has been requested. In a case where it is determined that the settlement has not been requested (NO in ACT220), the processing of the processor 31 proceeds to ACT221. In ACT221, the processor 31 determines whether or not settlement completion has been notified. In a case where it is determined that the settlement completion has not been notified (NO in ACT221), the processing of the processor 31 returns to ACT220. As described above, the processor 31 waits for the settlement request or the notification of the settlement completion in ACT220 and ACT221. In a case where it is determined that the settlement has been requested from the user terminal 300 (YES in ACT220) as described above, the processing of the processor 31 proceeds to ACT222.

In ACT222, the processor 31 transfers the settlement request to the virtual POS server 2 with a notification of the transaction code of the transaction to be processed. At this time, the processor 31 may transfer the request data transmitted from the user terminal 300 as it is to the virtual POS server 2 or may transmit the request data converted by a certain process to the virtual POS server 2. However, in a case where the electronic receipt ID has been obtained for the transaction to be processed, the processor 31 includes the electronic receipt ID in the request data. For example, the processor 31 searches the transaction management database DB31 for the data record DR1 having the field F11 in which the terminal code included in the request data has been set. The processor 31 includes the electronic receipt ID in the request data in a case where the electronic receipt ID has been set in the field F14 of the corresponding data record DR1. In a case where the request data transmitted from the user terminal 300 includes the settlement data, the processor 31 includes the settlement data as it is in the request data to be transmitted to the virtual POS server 2.

In a case where the electronic receipt ID set in the field F14 of the data record DR1 is transmitted from the user terminal 300, the processor 31 transfers the electronic receipt ID to the virtual POS server 2 as a second information processing apparatus through the communication interface 34. In ACT223, the processor 31 waits for the settlement completion to be notified while determining whether or not the settlement completion has been notified.

When the request data related to the settlement has been transferred from the mobile controller 3 under the standby state of ACT302 to ACT305 of FIG. 17, the processor 21 of the virtual POS server 2 determines that the settlement has been requested (YES in ACT304). Then, the processing of the processor 21 proceeds to ACT310. In ACT310, the processor 21 performs a settlement process for paying money in response to the request in the transferred request data. For example, the processor 21 determines that the request based on the request data transmitted from the mobile controller 3 is a settlement instruction input by the input device provided in the existing POS terminal. The processor 21 calculates the amount of money for the transaction identified by the notified transaction code by a process similar to that of the existing POS terminal. Then, the processor 21 requests the settlement server 500 to pay the calculated amount of money. For example, the processor 21 refers to the user database included in the database group DB11, determines a settlement method to be applied to the settlement, and obtains settlement information used for settlement by the settlement method. In a case where a plurality of settlement methods or a plurality of pieces of settlement information have been registered in the user database, one of them is selected in accordance with the operator's instruction in the user terminal 300 or under a predetermined condition. It should be noted that in a case where the request data includes the settlement information, for example, the processor 21 may determine a settlement method to be used for settlement on the basis of the settlement information and may use the settlement information as settlement information to be used for settlement.

In ACT311, the processor 21 determines whether or not the electronic receipt ID has been notified. For example, in a case where the electronic receipt ID is included in the request data requesting to perform settlement, the processor determines that the electronic receipt ID has been notified (YES in ACT311). Then, the processing of the processor 21 proceeds to ACT312. In ACT312, the processor 21 performs a process for registering the transaction data related to the transaction for which the settlement has been completed as described above in the electronic receipt server 600 such that the user identified by the electronic receipt ID included in the request data can browse the transaction data. It should be noted that this process may be similar to that performed by an existing electronic receipt service, for example. What data the processor 21 includes in the transaction data follows the rules in the electronic receipt service, for example.

When the customer wishes to perform an operation for settlement through the payment machine 5, the customer designates the payment machine 5 by a predetermined operation such as touching the button BU32 on the payment screen SC3. In response to it, the processor 301 of the user terminal 300 determines that the payment machine 5 has been designated (YES in ACT138 of FIG. 12). Then, the processing of the processor 301 proceeds to ACT140. In ACT140, the processor 301 displays a payment barcode screen on the touch panel 304. The payment barcode screen is a screen on which a payment barcode indicating data necessary for the payment machine 5 to obtain data regarding the description of the transaction from the virtual POS server 2 is displayed. It should be noted that although the illustration of the detailed process is omitted, the processor 301 obtains the payment barcode from the virtual POS server 2 via the mobile controller 3 and displays the payment barcode on the payment barcode screen.

The customer causes a scanner provided in the payment machine 5, which is not used by other customers, to read the payment barcode. In response to it, the payment machine 5 requests the virtual POS server 2 to transfer the settlement data in accordance with the data indicated by the payment barcode. For example, the payment machine 5 transmits the request data including the transaction code included in the data indicated by the payment barcode to the virtual POS server 2.

When the request data for the transfer request including the transaction code of the transaction to be processed under the standby state of ACT302 or ACT305 of FIG. 17 is received, the processor 21 of the virtual POS server 2 determines that the transfer of the settlement data has been requested (YES in ACT305). Then, the processing of the processor 21 proceeds to ACT313. In ACT313, the processor 21 transmits settlement data indicating the description of the transaction to be subjected to the transaction process and required for settlement in the payment machine 5 to the payment machine 5 that requested the transfer. It should be noted that the settlement data may be data similar to settlement data transferred from a registration machine to a payment machine in an existing semi-self-transaction processing system, for example. In ACT314, the processor 21 waits for settlement completion in the payment machine 5 while determining whether or not the settlement in the payment machine 5 that had transmitted the settlement data as described above has been completed.

When receiving the settlement data transmitted from the virtual POS server 2, the payment machine 5 performs settlement for the transaction while receiving the operator's operation. The payment machine 5 issues various types of printed matter such as a receipt and a coupon, as necessary. When the settlement is completed, the payment machine 5 notifies the virtual POS server 2 of the completion. In response to it, the processor 21 of the virtual POS server 2 determines that the settlement in the payment machine 5 has been completed (YES in ACT314 of FIG. 17). Then, the processing of the processor 21 proceeds to ACT315. It should be noted that even after the processor 21 completes the electronic receipt registration in ACT312, the processing of the processor 21 proceeds to ACT315. Further, in a case where the electronic receipt ID is not included in the request data requesting to perform settlement, the processor 21 determines that the electronic receipt ID has not been notified (NO in ACT311). Then, the processing of the processor 21 skips ACT312 and proceeds to ACT315. In ACT315, the processor 21 notifies the mobile controller 3 of the settlement completion. Then, the processor 21 terminates the transaction process.

As described above, the processor 21 of the virtual POS server 2 performs each of transaction processes as information processing for processing a transaction in accordance with instructions from different target terminals. Accordingly, a plurality of processing means for performing transaction processes in response to instructions from different terminal devices are realized. By the processor 21 performing the information processing based on the virtual POS application AP21 as described above, the computer having the processor 21 as the central portion functions as a plurality of processing means.

When the settlement completion is notified by the virtual POS server 2 as described above (YES in ACT221 or ACT223 of FIG. 16), the processing of the processor 31 of the mobile controller 3 proceeds to ACT224 in either case. It should be noted that when the processing of the processor 21 of the virtual POS application AP21 proceeds from ACT311 or ACT312 to ACT315 of FIG. 17, the processor 31 determines that the settlement completion has been notified (YES in ACT221 of FIG. 16). Further, when the processor 21 of the virtual POS application AP21 proceeds to ACT315 from ACT314 of FIG. 17, the processor 31 determines that the settlement completion has been notified (YES in ACT223 of FIG. 16). In ACT224 of FIG. 16, the processor 31 notifies the user terminal 300 of the settlement completion.

After the processor 301 of the user terminal 300 requests to perform settlement in ACT139 of FIG. 12 or displays the payment barcode screen in ACT140 of FIG. 12, the processing of the processor 301 proceeds to ACT141. In ACT141, the processor 301 waits for the settlement completion to be notified while determining whether or not the settlement completion from the mobile controller 3 has been notified. In a case where it is determined from the mobile controller 3 that the settlement completion has been notified (YES in ACT141), the processing of the processor 301 proceeds to ACT142. In ACT142, the processor 301 causes the touch panel 304 to display a completion screen. The completion screen is a screen for notifying the customer that the settlement has been completed.

After confirming the completion screen, the customer declares that the completion screen has been confirmed by a predetermined operation such as touching a button displayed on the completion screen. In response to it, the processing of the processor 301 of the user terminal 300 proceeds to ACT143 of FIG. 12. It should be noted that the processing of the processor 301 may proceed to ACT143 when the elapsed time reaches a predetermined time in a state in which the completion screen is displayed.

In ACT143 of FIG. 12, the processor 301 of the user terminal 300 displays a scan screen for check-out on the touch panel 304. The scan screen for check-out is a screen for reading the two-dimensional code TC2 for check-out. The processor 301 may, for example, activate the camera 305 and generate a scan image by superimposing a character message prompting the customer to read the two-dimensional code TC2 and a line indicating a position to which the two-dimensional code TC2 should be made to face on the image thus obtained by the camera 305.

When the scan screen for check-out is displayed on the touch panel 304, the customer directs the camera 305 of the user terminal 300 to the two-dimensional code TC2 such that the two-dimensional code TC2 posted near the exit of the store is reflected on the scan screen. In ACT144 of FIG. 12, the processor 301 of the user terminal 300 waits for the two-dimensional code to be read while determining whether or not the two-dimensional code has been read. At this time, the processor 301 repeatedly analyzes the image obtained by the camera 305 and attempts to read the two-dimensional code. The reading of the two-dimensional code may be performed as a process based on the smartphone POS application AP301 or may be performed as a process based on another application program for reading the two-dimensional code. In a case where it is determined that the two-dimensional code has been read (YES in ACT144), the processing of the processor 301 proceeds to ACT145.

In ACT145 of FIG. 12, the processor 301 of the user terminal 300 determines whether or not the data indicated by the read two-dimensional code is the check-out data. In a case where it is determined that the data indicated by the read two-dimensional code is not the check-out data (NO in ACT145), the processing of the processor 301 returns to ACT144. At this time, the processor 301 may cause the touch panel 304 to display a screen for notifying the customer that the erroneous two-dimensional code has been read.

On the other hand, in a case where it is determined that the data indicated by the read two-dimensional code is the check-out data (YES in ACT145), the processing of the processor 301 proceeds to ACT146. In ACT146, the processor 301 requests the mobile controller 3 to check out.

After the processor 31 of the mobile controller 3 notifies the settlement completion in ACT224 of FIG. 16, the processing of the processor 31 proceeds to ACT225. In ACT225, the processor 31 waits for the check-out to be requested while determining whether or not the check-out has been requested from the user terminal 300. In a case where it is determined that the check-out has been requested from the user terminal 300 (YES in ACT225), the processing of the processor 31 proceeds to ACT226.

In ACT226 of FIG. 16, the processor 31 of the mobile controller 3 performs a check-out process. The check-out process is a process such as clearing data stored in the main memory 32 and the auxiliary storage device 33 for managing the processed transaction. It should be noted that the virtual POS server 2 may terminate the process related to the corresponding transaction in response to the settlement completion or may terminate the process related to the transaction in response to an instruction from the mobile controller 3. In the latter case, the processor 31 of the mobile controller 3 makes the above instruction to the virtual POS server 2 in the check-out process. Further, the history database indicating the history of the user's operation including incorrect barcode scan may be managed by the store server 1, the virtual POS server 2, the mobile controller 3, another server (not shown), or the like. In this case, the processor 31 performs a process for updating the history database in the check-out process to reflect the history of the operation related to the current transaction. In ACT227 of FIG. 16, the processor 31 of the mobile controller 3 notifies the user terminal 300 of check-out completion. Then, the processor 31 terminates the mediation process.

After the processor 301 of the user terminal 300 requests the mobile controller 3 to check out in ACT146 of FIG. 12, the processing of the processor 301 proceeds to ACT147. In ACT147, the processor 301 waits for the notification of the check-out completion from the mobile controller 3 while determining whether or not the notification of the check-out completion has been received from the mobile controller 3. In a case where it is determined that the notification of the check-out completion has been received from the mobile controller 3 (YES in ACT147), the processing of the processor 301 proceeds to ACT148. In ACT148, the processor 301 clears various types of data temporarily used for the current shopping, such as the check-in data stored in ACT107 of FIG. 9. Thereafter, the processing of the processor 301 returns to ACT101 of FIG. 9.

After the processor 401a of the cart terminal 400 requests to check in in ACT163 of FIG. 13, the processing of the processor 401a proceeds to ACT164. In ACT164, the processor 401a determines whether or not the check-in completion has been notified. In a case where it is determined that the check-in completion has not been notified (NO in ACT164), the processing of the processor 401a proceeds to ACT165. In ACT165, the processor 401a determines whether or not a check-in error has been notified. In a case where it is determined that a check-in error has not been notified (NO in ACT165), the processing of the processor 401a returns to ACT164. As described above, the processor 401a waits for the check-in completion or the error to be notified in ACT164 and ACT165. In a case where notification data for the error notification in ACT188 of FIG. 14 or ACT203 of FIG. 15 has been received by the wireless communication device 401d, the processor 401a determines that the check-in error has been notified (YES in ACT165). Then, the processing of the processor 401a proceeds to ACT166.

In ACT166 of FIG. 13, the processor 401a of the cart terminal 400 causes the touch panel 401e to display an error screen. The error screen is a screen for notifying the customer that the check-in is impossible. It should be noted that for example, for the error notification in ACT188 of FIG. 14, the processor 31 displays an error screen notifying that the check-in is impossible because the store is congested and prompting the user to re-try the check-in after a while. When an instruction to cancel the display of the error screen is made by the customer operating the GUI element or the like displayed on the error screen, the processing of the processor 401a returns to the standby state in ACT162.

On the other hand, the processor 401a determines that the check-in completion has been notified (YES in ACT164) when the wireless communication device 401d receives the notification data (see ACT204 of FIG. 15) for notification of the above-mentioned check-in completion from the mobile controller 3. Although the illustration is omitted from FIG. 15, the processor 401a requests the mobile controller 3 of the registration, the change in quantity, the cancel, or the settlement in the same manner as the processor 301 described above or causes the touch panel 401e to display the payment barcode screen in accordance with the customer's operation. However, the customer's operation received by the processor 401a may be different from that of the processor 301. For example, a barcode displayed on a commodity to be registered as a purchased commodity is read by the scanner 402. As described above, the mobile controller 3 and the virtual POS server 2 perform a process according to the above-mentioned request or the transfer request from the payment machine 5 also in the mediation process and the transaction process in which the cart terminal 400 is the target terminal as in the case where the user terminal 300 is the target terminal as described above.

As described above, the processor 21 of the virtual POS server 2 performs each of the transaction processes as the information processing for processing the transaction in accordance with instructions from the different target terminals. Accordingly, the plurality of processing means that performs the transaction process in response to the instructions from the different terminal devices is realized. By the processor 21 performing the information processing based on the virtual POS application AP21 as described above, the computer having the processor 21 as the central portion functions as the plurality of processing means.

The processor 401a of the cart terminal 400 requests settlement in a manner similar to the process in ACT139 of FIG. 12 or causes the payment barcode screen to be displayed in a manner similar to the process in ACT140. Thereafter, the processing of the processor 401a proceeds to ACT171 of FIG. 13. In ACT171, the processor 401a of the cart terminal 400 waits for the settlement completion to be notified while determining whether or not the notification of the settlement completion has been received. In a case where it is determined that the notification of the settlement completion (ACT224 of FIG. 16) from the mobile controller 3 or the notification of the settlement completion from the payment machine 5 has been received (YES in ACT171), the processing of the processor 401a proceeds to ACT172. In ACT172, the processor 401a causes the touch panel 401e to display an end screen. The end screen is, for example, a screen for notifying the customer that the transaction has been completed. In ACT173, the processor 401a clears the various types of data temporarily used for the current shopping. Thereafter, the processing of the processor 401a returns to the standby state in ACT162.

As described above, the transaction processing system 800 according to the embodiment limits the number of transaction processes that the processor 21 of the virtual POS server 2 performs concurrently by using the user terminals 300 as the target terminals to be less than the number of transaction processes that the processor 21 can perform concurrently. Accordingly, the processor 21 can constantly perform the transaction processes by using the cart terminals 400 as the target terminals and it is possible to lower the possibility of a situation where the purchased commodities cannot be registered using the cart terminals.

Further, the transaction processing system 800 according to the embodiment sets the number obtained by subtracting the limit number of cart terminals 400 simultaneously operated in the store from the maximum number as the allowable number as in the above-described specific example. Accordingly, the processor 21 of the virtual POS server 2 can constantly perform the transaction processes using all the cart terminals 400 as the target terminals and it is possible to prevent the possibility of a situation where the purchased commodities cannot be registered using the cart terminals 400.

Further, the transaction processing system 800 according to the embodiment stores the limit number in the main memory or the auxiliary storage device 33 of the mobile controller 3 and updates the stored limit number to a numerical value inputted in accordance with the operator's operation. Therefore, it is possible to individually set the limit number for each store and an operation according to the management policy of each store becomes possible.

The above-mentioned embodiment can be variously modified as follows. For example, the transaction processing system 800 does not need to include the mobile controller 3 and may directly receive requests from the user terminal 300 and the cart terminal 400 through the virtual POS server 2. The management process may be performed by the processor 21 of the virtual POS server 2.

For example, the transaction processing system 800 may include a plurality of virtual POS servers 2 and the plurality of virtual POS servers 2 may share and perform a plurality of transaction processes. Alternatively, a single transaction process may be shared and processed by a plurality of information processing apparatuses. For example, the process for registering the purchased commodities and the process for paying for the purchased commodities may be performed by separate different information processing apparatuses.

The transaction to be processed by the transaction processing system 800 is not limited to the sale of the commodities displayed in the store, and may be another type of transaction such as cooking and offering food and beverages.

Alternatively, the terminal device belonging to the second type lent to the customer by the store may be carried by the user without being attached to the shopping cart C1 or such a terminal device and the cart terminal 400 may be both used.

Each function realized by the processor 11, 21, 31, 301, and 401a in the information processing can be realized by hardware that performs information processing not based on a program, such as a logic circuit. Alternatively, each of the above-mentioned functions may be realized by combining software control with the hardware such as the logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A point-of-sale (POS) transaction processing system, comprising:
a plurality of mobile computing devices including a plurality of mobile computing devices of a first type and a plurality of mobile computing devices of a second type, wherein the mobile computing devices of the first type are personal mobile computing devices of customers of a store, and the mobile computing devices of the second type are mobile computing devices installed in shopping carts at the store;
a virtual POS server that is configured to perform a plurality of sales transaction processes for processing sales transactions in accordance with instructions from the plurality of mobile computing devices; and
a management processing apparatus that is configured to perform a management process for managing the sales transaction processes performed by the virtual POS server and a sales mediation process for mediating the virtual POS server and the plurality of mobile computing devices for the sales transaction processes, wherein the management processing apparatus includes
a communication interface that is configured to communicate with the plurality of mobile computing devices and the virtual POS server,
a storage device that is configured to store an allowable number of sales transaction processes of mobile computing devices of the first type that the virtual POS server is allowed to perform concurrently, a mobile computing device list that includes identifiers of mobile computing devices of the second type that are in operation for transmitting instructions for carrying out sales transactions, and a number of running sales transaction processes being performed by the virtual POS server in accordance with instructions from the mobile computing devices of the first type, and
a processor that is configured to:
determine whether or not an activation notification, transmitted from a first mobile computing device of the second type, is received by the communication interface, wherein the activation notification includes an identifier of the first mobile computing device of the second type,
if it is determined that the activation notification is received by the communication interface, update the mobile computing device list, wherein updating the mobile computing device list comprises adding the identifier of the first mobile computing device of the second type to the mobile computing device list, and the identifier is eliminated from the mobile computing device list when a stop operation of the first mobile computing device of the second type is detected,
if it is determined that the activation notification is not received by the communication interface, determine whether or not a request to start a sales transaction, transmitted from any of the mobile computing devices, is received by the communication interface, wherein the request to start a sales transaction includes an identifier of either a first mobile computing device of the first type or a second mobile computing device of the second type,
if it is determined that the request to start a sales transaction is received by the communication interface, determine whether the request to start a sales transaction is received from the first mobile computing device of the first type or the second mobile computing device of the second type by confirming whether or not the identifier included in the request to start a sales transaction is included in the mobile computing device list,
if it is determined that the request to start a sales transaction is from the first mobile computing device of the first type, compare the number of running sales transaction processes being performed in accordance with instructions from the mobile computing devices of the first type with the allowable number,
if the number of running sales transaction processes being performed in accordance with instructions from the mobile computing devices of the first type is equal to the allowable number, reject the request to start a sales transaction, wherein rejecting the request to start a sales transaction includes transmitting an error notification to the first mobile computing device of the first type via the communication interface,
if the number of running sales transaction processes being performed in accordance with instructions from the mobile computing devices of the first type is less than the allowable number, or if it is determined that the request to start a sales transaction is from the second mobile computing device of the second type, start the sales mediation process, and update the number of running sales transaction processes being performed in accordance with instructions from the mobile computing devices of the first type by incrementing the number of running sales transaction processes being performed in accordance with instructions from the mobile computing devices of the first type in a case where the sales mediation process is for mediating the virtual POS server and the first mobile computing device of the first type, and if it is determined that the request to start a sales transaction,
transmitted from any of the mobile computing devices, is not received by the communication interface, update the number of running sales transaction processes being performed in accordance with instructions from the mobile computing devices of the first type by decrementing the number of running sales transaction processes being performed in accordance with instructions from the mobile computing devices of the first type in a case where the sales mediation process for mediating the virtual POS server and one of the mobile computing devices of the first type is completed.

2. The POS transaction processing system according to claim 1, wherein the processor is further configured to:
if it is determined that the request to start a sales transaction is received by the communication interface, determine whether or not the virtual POS server is capable of performing a sales transaction process of a new sales transaction, and reject, in a case where the processor determines that the virtual POS server is incapable of performing the sales transaction process of the new sales transaction, the request to start a sales transaction, transmitted from any of the mobile computing devices.

3. The POS transaction processing system according to claim 2, wherein if it is determined that the request to start a sales transaction is received by the communication interface, and if it is determined that the request to start a sales transaction is from the second mobile computing device of the second type, the sales mediation process comprises the processor mediating the virtual POS server and the second mobile computing device of the second type by transmitting: (1) a request to the virtual POS server to change a selection of a commodity to be purchased, (2) a request to the virtual POS server to cancel a selection of a commodity to be purchased, or (3) a request to the second mobile computing device of the second type for payment information.

4. The POS transaction processing system according to claim 2, wherein
the storage device is further configured to store a maximum number of sales transaction processes that the virtual POS server is able to perform concurrently based on a total processing capacity of the virtual POS server, and
the processor is further configured to, if it is determined that the request to start a sales transaction is received by the communication interface, determine whether or not the virtual POS server is capable of performing the sales transaction process of the new sales transaction, by comparing a total number of running sales transaction processes being performed by the virtual POS server with the maximum number, and wherein
performing the sales transaction process of the new sales transaction by the virtual POS server includes: (1) updating a database of sales transactions to indicate a change to a selection of a commodity to be purchased, (2) updating the database of sales transactions to indicate a cancelation of a selection of a commodity to be purchased, (3) settling the new sales transaction, the settlement comprising calculating, using information that is included in the database of sales transactions and that corresponds to the new sales transaction, an amount of money required for purchasing commodities of the new sales transaction, and transmitting a request to an online settlement server for payment of the amount of money, as calculated by the virtual POS server, or (4) transferring the information that is included in the database of sales transactions and that corresponds to the new sales transaction, to a physical POS terminal that is configured to calculate the amount of money required for purchasing the commodities of the new sales transaction, and instructing a customer to pay the amount of money, as calculated by the physical POS terminal.

5. The POS transaction processing system according to claim 1, wherein the mobile computing devices of the first type are brought into the store by customers, and the mobile computing devices of the second type are lent to customers by the store, and the mobile computing devices of the first type and the second type receive operations by respective customers for instructing performance of the sales transaction processes.

6. The POS transaction processing system according to claim 4, wherein
the storage device is further configured to store a guaranteed number of sales transaction processes of mobile computing devices of the second type that the virtual POS server is able to perform concurrently, and
the processor is further configured to store a number obtained by subtracting the guaranteed number from the maximum number, in the storage device as the allowable number.

7. The POS transaction processing system according to claim 6, further comprising:
an input device that is configured to input a numerical value in accordance with an operation by an operator of the input device, wherein the processor is further configured to update the guaranteed number based on the input numerical value.
